(19) United States
(12) Patent Application Publication
(10) Pub. No.: US 2026/0295414 A1
(43) Pub. Date: Oct. 1, 2026

(54) GAME SYSTEM, COMPUTER-IMPLEMENTED METHOD, AND ONE OR MORE NON-TRANSITORY COMPUTER-READABLE MEDIA

(71) Applicant: NINTENDO CO., LTD., Kyoto (JP)

(72) Inventors: Yasutaka TAKEUCHI, Kyoto (JP); Yoshito UEYAMA, Kyoto (JP)

(21) Appl. No.: 19/570,936

(22) Filed: Mar. 18, 2026

(30) Foreign Application Priority Data
Mar. 27, 2025 (JP) 2025-054375

(51) Int. Cl. A63F 13/533; A63F 13/537; A63F 13/69; A63F 13/79; A63F 13/822

(52) U.S. Cl. CPC A63F 13/533; A63F 13/537; A63F 13/69; A63F 13/79; A63F 13/822

(57) ABSTRACT

An example of a game system according to an exemplary embodiment includes a first game apparatus, a second game apparatus, a server, and a first communication terminal. The first game apparatus transmits first information corresponding to a first content to the server during a first game related to a first account, and the second game apparatus transmits second information corresponding to a second content to the server during the first game related to a second account. The first communication terminal transmits to the server a first instruction to move the second information from a second information list to a first information list. The first game apparatus acquires from the server the second information moved to the first information list and generates a third content that can be used in the first game.

### CROSS REFERENCE TO RELATED APPLICATION

This application claims priority to Japanese Patent Application No. 2025-054375 filed on Mar. 27, 2025, the entire contents of which are incorporated herein by reference.

### FIELD

An exemplary embodiment relates to a game system, a computer-implemented method, and one or more non-transitory computer-readable media that enable the execution of an application.

### BACKGROUND AND SUMMARY

Conventionally, there is a game system where a user can acquire and use an item during a game.

The above conventional technique does not transmit and receive a content to and from users.

An exemplary embodiment provides a game system, a computer-implemented method, and a game program that enable a content to be transmitted and received to and from users.

An exemplary embodiment employs the following configurations.

### First Configuration

A first configuration is a game system including a first game apparatus, a second game apparatus, and a first communication terminal. The first game apparatus is configured to perform operations including: executing a first application associated with a first account; and during the execution of the first application, based on an operation input, transmitting first information associated with a specified first content to a server. The second game apparatus is configured to perform operations including: executing the first application associated with a second account; and during the execution of the first application, based on an operation input, transmitting second information associated with a specified second content to the server. The first communication terminal is configured to perform operations including: executing a second application associated with the first account; and during the execution of the second application, when a predetermined condition is satisfied, acquiring a second information list associated with the second account and including the second information from the server, acquiring a first information list associated with the first account and including the first information from the server, and based on an operation input, transmitting to the server a first instruction to move the second information specified from the second information list to the first information list. The first game apparatus is further configured to perform operations including: during the execution of the first application, acquiring from the server the second information moved to the first information list, and based on the second information, generating a third content that can be used in the first application.

Based on the above, a first user corresponding to a first account can acquire second information transmitted from a second user corresponding to a second account and use a third content based on the second information in a first application. Thus, it is possible to transmit and receive a content to and from users.

### Second Configuration

According to a second configuration, in the above first configuration, the game system may further include a second communication terminal capable of connecting to the server. The second communication terminal may be configured to perform operations including: executing a third application associated with the second account; and during the execution of the third application, acquiring the second information list from the server, and generating an image associated with the second information list or acquiring the image from the server. The first communication terminal may be further configured to perform operations including: acquiring the second information list from the server based on the image.

Based on the above, a first communication terminal reads an image and thereby can acquire a second information list.

### Third Configuration

According to a third configuration, in the above first or second configuration, the first content may be a first equipment item object with which a player character in a virtual space is equipped during the execution of the first application, or may be a first additional item object that changes a parameter regarding an ability of the player character during the execution of the first application. The second content may be a second equipment item object with which a player character in a virtual space is equipped during the execution of the first application, or may be a second additional item object that changes a parameter regarding an ability of the player character during the execution of the first application.

Based on the above, it is possible to transmit and receive an equipment item or an additional item to and from users.

### Fourth Configuration

According to a fourth configuration, in any of the above first to third configurations, an upper limit may be set on the number of times the first instruction is given during a predetermined period.

Based on the above, it is possible to restrict the movement of a content between users. Thus, it is possible to maintain the balance of the game.

### Fifth Configuration

According to a fifth configuration, in any of the above first to fourth configurations, the number of contents that can be managed using the first communication terminal may be greater than the number of contents that can be saved in the first game apparatus.

Based on the above, a first communication terminal and a server can manage more contents than contents that can be saved in a game apparatus.

### Sixth Configuration

According to a sixth configuration, in any of the above first to fifth configurations, the first game apparatus may be further configured to perform operations including: during the execution of the first application, based on an operation input, acquiring the second information included in the first information list from the server.

Based on the above, a user can acquire second information based on an operation and acquire the third content.

### Seventh Configuration

According to a seventh configuration, in any of the above first to sixth configurations, the first game apparatus may be further configured to perform operations including: during the execution of the first application, based on an operation input, controlling a player character in a virtual space, setting a first area in the virtual space, and when the first content is included in the first area, transmitting the first information to the server.

Based on the above, during the execution of the first application, a first area is set in a virtual space where a player character is controlled, and if a first content is included in the first area, it is possible to transmit first information to a server.

### Eighth Configuration

According to an eighth configuration, in the above seventh configuration, the third content may be an object that can be used by the player character. The first game apparatus may be further configured to perform operations including: during the execution of the first application, setting a second area in the virtual space, and causing the third content generated based on the second information to appear from the second area.

Based on the above, it is possible to cause the third content to appear in a virtual space.

Another configuration may be a computer-implemented method performed by the above game system, or may be a game program executed by the above first game apparatus and second game apparatus.

According to an exemplary embodiment, it is possible to transmit and receive a content to and from users.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system 1 according to an exemplary embodiment;

FIG. 2 is an example non-limiting diagram showing an example of the configuration of a game apparatus 20;

FIG. 3 is an example non-limiting diagram showing an example of the configuration of a smartphone 30;

FIG. 4 is an example non-limiting diagram showing an example of a during-game screen displayed when a game of a game title TA is executed in the game apparatus 20;

FIG. 5 is an example non-limiting diagram showing an example of a game image displayed when a game of a game title TB is executed in the game apparatus 20;

FIG. 6 is an example non-limiting diagram showing the flow of the deposit and the withdrawal of an item;

FIG. 7 is an example non-limiting diagram showing the flow of the movement of an item between the titles using a smartphone app;

FIG. 8 is an example non-limiting diagram showing the flow of the handing over and the taking over of an item between users using share boxes;

FIG. 9 is an example non-limiting diagram showing an example of a screen on a smartphone 30X and is an example non-limiting diagram showing an example of a screen displayed when a user's box is selected;

FIG. 10 is an example non-limiting diagram showing an example of a screen on the smartphone 30X and is an example non-limiting diagram showing an example of an item operation screen displayed when an item A1 in the game title TA is selected;

FIG. 11 is an example non-limiting diagram showing an example of an inter-title movement screen displayed in a case where an "inter-title movement" button is operated on the item operation screen in FIG. 10;

FIG. 12 is an example non-limiting diagram showing an example of an item handing-over screen displayed in a case where a "give to someone" button is operated on the item operation screen in FIG. 10;

FIG. 13 is an example non-limiting diagram showing an example of a screen on the smartphone 30X and is an example non-limiting diagram showing an example of a screen displayed when share boxes Sy of a user Y are selected;

FIG. 14 is an example non-limiting diagram showing an example of a screen on the smartphone 30X and is an example non-limiting diagram showing an example of a screen displayed when the item A1 in the share boxes Sy is selected;

FIG. 15 is an example non-limiting diagram showing an example of a screen for depositing or withdrawing an item in the game apparatus 20;

FIG. 16 is an example non-limiting diagram showing an example of an item deposit screen displayed on the game apparatus 20;

FIG. 17 is an example non-limiting diagram showing an example of an item withdrawal screen;

FIG. 18 is an example non-limiting diagram showing the state where an item is deposited on a during-game screen;

FIG. 19 is an example non-limiting diagram showing the state where an item is withdrawn on a during-game screen;

FIG. 20 is an example non-limiting diagram showing examples of various pieces of data stored in the game apparatus 20;

FIG. 21 is an example non-limiting diagram showing examples of various pieces of data stored in the smartphone 30;

FIG. 22 is an example non-limiting diagram showing examples of various pieces of data stored in a server 10;

FIG. 23 is an example non-limiting flow chart showing an example of a game apparatus process performed by the game apparatus 20;

FIG. 24 is an example non-limiting flow chart showing an example of an item deposit/withdrawal process in step S14;

FIG. 25 is an example non-limiting flow chart showing an example of a smartphone process performed by the smartphone 30X;

FIG. 26 is an example non-limiting flow chart showing an example of an item box process in step S44;

FIG. 27 is an example non-limiting flow chart showing an example of a share box process in step S46;

FIG. 28 is an example non-limiting flow chart showing an example of a server process performed by the server 10;

FIG. 29 is an example non-limiting flow chart showing an example of an inter-title movement process in step S79; and

FIG. 30 is an example non-limiting flow chart showing an example of an item handing-over/taking-over process in step S80.

### DETAILED DESCRIPTION OF NON-LIMITING EXAMPLE EMBODIMENTS

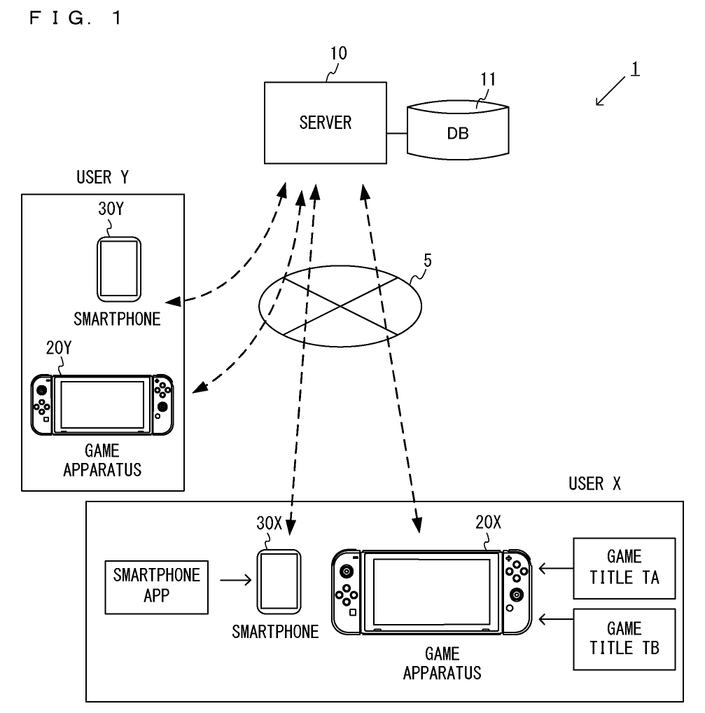

A game system according to an example of an exemplary embodiment is described below. FIG. 1 is a diagram showing an example of a game system 1 according to an exemplary embodiment. As shown in FIG. 1, the game system 1 includes a server 10, game apparatuses 20 (e.g., 20X and 20Y), and smartphones 30 (e.g., 30X and 30Y). Each game apparatus 20 is connected to the server 10 via a network 5 (e.g., the Internet) so that the game apparatus 20 can communicate with the server 10. Each smartphone 30 is connected to the server 10 via the network 5 so that the smartphone 30 can communicate with the server 10.

The server 10 includes one or more server apparatuses. The server 10 includes a processor, a storage device, and a communication section (not shown). The server 10 includes a database 11. The database 11 stores information regarding each user (e.g., information regarding a user ID, a user name, an item box, a share box described below, and the like).

Each game apparatus 20 can execute various game programs including a game title TA and a game title TB. Each of the game title TA and the game title TB is one of the same "game title T" series. For example, games of the game titles TA and TB may be role-playing games. The game of the game title TB may be a game released after the game title TA. The game of the game title TB may be a game in a different version released on the same day or during the same period as the game title TA.

For example, if a dedicated memory card (described below) having stored therein the game program for the game title TA is connected to the game apparatus 20, the game of the game title TA is executed by the game apparatus 20. If a dedicated memory card having stored therein the game program for the game title TB is connected to the game apparatus 20, the game of the game title TB is executed by the game apparatus 20. The game programs for the game titles TA and TB may be stored in a memory (e.g., a non-volatile memory 23 described below) built into the game apparatus 20.

Here, the game apparatus 20X is used by a user X, and the game apparatus 20Y is used by a user Y. In addition to the game apparatuses 20X and 20Y, game apparatuses 20 used by many users are connected to the server 10 via the network 5.

Each smartphone 30 can execute various applications. On the smartphone 30, an application corresponding to the above game title T is installed. Hereinafter, the application corresponding to the game title T is simply referred to as a "smartphone app".

The smartphone 30X is used by the user X, and the smartphone 30Y is used by the user Y. In addition to the smartphones 30X and 30Y, smartphones 30 used by many users are connected to the server 10 via the network 5. Each smartphone 30 may be any communication terminal such as a smart device, a tablet terminal, a personal computer, a wearable device or the like.

### Configuration of Game Apparatus 20

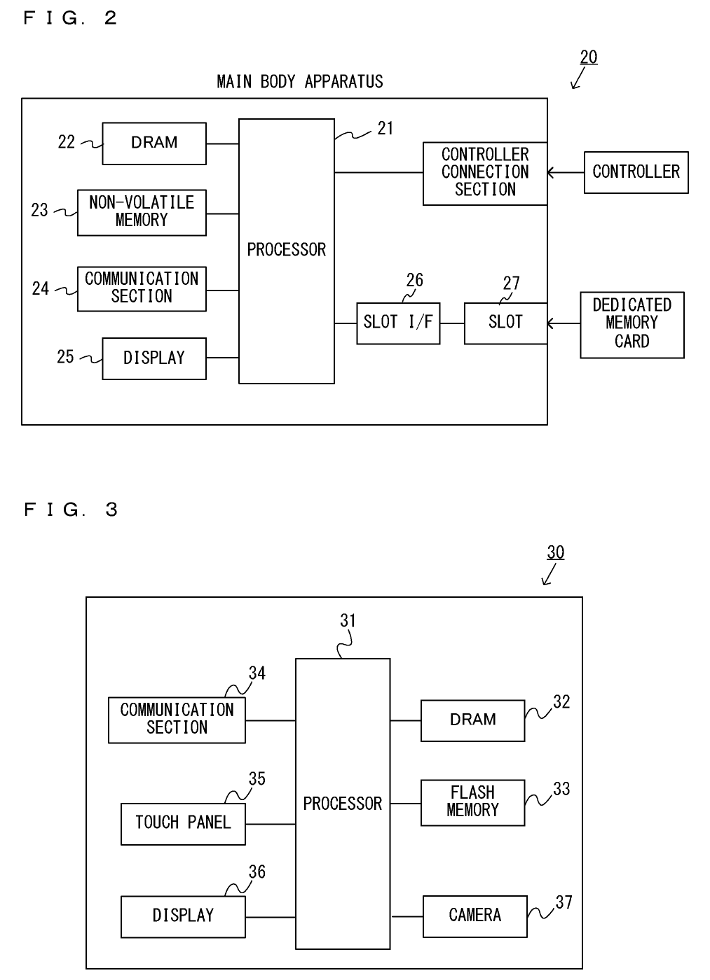

An example of the configuration of each game apparatus 20 is described below. FIG. 2 is a diagram showing an example of the configuration of the game apparatus 20. The game apparatus 20 according to an exemplary embodiment includes a main body apparatus and a controller.

The game apparatus 20 includes a controller operated by the user. In the controller, a plurality of buttons for performing game operations and an analog stick for performing a direction indication operation are provided. The controller is connected to a main body apparatus of the game apparatus 20 in a wired or wireless manner via a controller connection section provided in the main body apparatus.

The game apparatus 20 includes a processor 21, a DRAM 22, and a non-volatile memory 23. The processor 21 is an information processing section that executes various types of information processing (e.g., game processing) to be executed by the game apparatus 20, and for example, includes one or more CPUs (Central Processing Units) and one or more GPUs (Graphics Processing Units). The processor 21 may be configured only by a CPU, or may be configured by a SoC (System-on-a-Chip) that includes a plurality of functions such as a CPU function and a GPU function. The processor 21 reads a game program (e.g., the game program for the game title TA or the game program for the game title TB) stored in a non-transitory storage medium such as the non-volatile memory 23, a dedicated memory card connected to a slot, or the like into the DRAM 22 and executes the game program.

The game apparatus 20 also includes a slot interface (hereinafter abbreviated as "I/F") 26 and a slot 27. Into the slot 27, a non-volatile memory (hereinafter referred to as a "dedicated memory card") dedicated to the game apparatus 20 and an information processing apparatus of the same type as the game apparatus 20 can be inserted. The dedicated memory card stores a game program for executing a game and data used during the execution of the game. In accordance with an instruction from the processor 21, the slot I/F 26 reads and writes data from and to the dedicated memory card attached to the slot 27.

The game apparatus 20 also includes a display 25. The display 25 displays an image generated by the game apparatus 20. The display 25 may be a display device of any type such as a liquid crystal display device, an organic EL display device, or the like.

The game apparatus 20 also includes a communication section 24. The communication section 24 is connected to the processor 21. The communication section 24 performs wired or wireless communication with an external apparatus via the network 5.

In addition to the components shown in FIG. 2, the game apparatus 20 includes a battery that supplies power and an output terminal for outputting an image and audio to a display device (e.g., a television) different from the display 25.

### Configuration of Smartphone 30

Next, an example of the configuration of each smartphone 30 is described. FIG. 3 is a diagram showing an example of the configuration of the smartphone 30.

The smartphone 30 according to an exemplary embodiment is a known smartphone, and for example, includes a processor 31, a DRAM 32, a non-volatile memory 33, a communication section 34, a touch panel 35, a display 36, and a camera 37.

The processor 31 executes various applications including the smartphone app corresponding to the above game title T described below, using the DRAM 32. The non-volatile memory 33 stores various application programs and pieces of data. The communication section 34 wirelessly communicates with an external apparatus via the network.

The touch panel 35 is provided on the display 36 and detects a touch operation of the user. The display 36 is a display device for displaying an image generated by the processor 31.

### Overview of Game

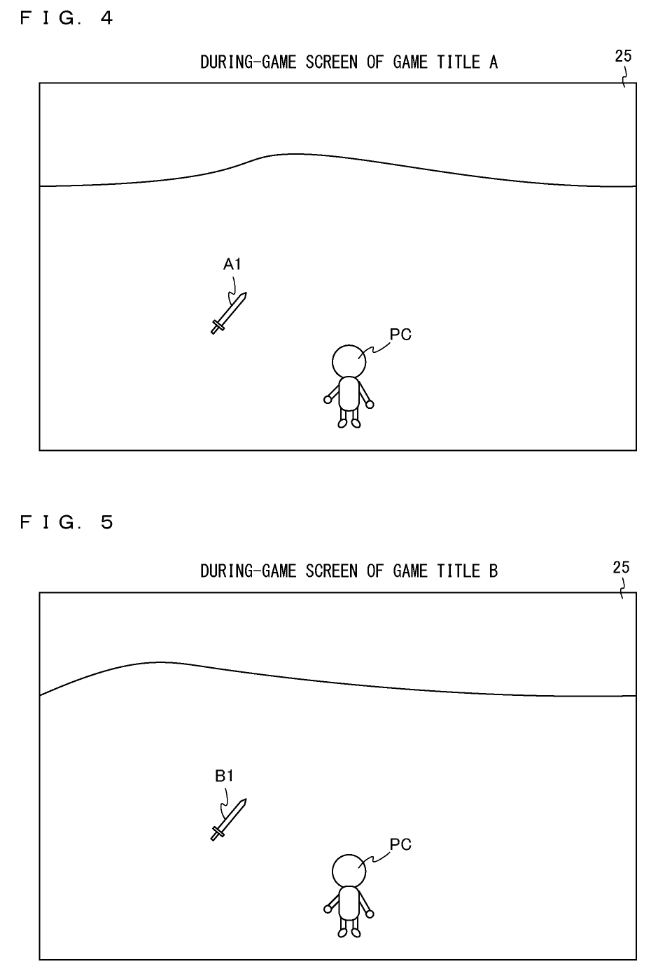

Next, an overview of a game performed in each game apparatus 20 is described. FIG. 4 is a diagram showing an example of a during-game screen displayed when the game of the game title TA is executed in the game apparatus 20.

As shown in FIG. 4, the user performs a game while moving a player character PC placed in a virtual space (a game space) on a field F, using the controller. The player character PC performs the game while acquiring a plurality of types of items. For example, an item A1 is placed in the virtual space, and the player character PC acquires the item A1. The plurality of types of items include a plurality of types of equipment items with which the player character PC is equipped, a plurality of types of additional items that change a parameter regarding the ability of the player character PC, and currency items.

For example, the equipment items include a plurality of types of weapon items and a plurality of types of protective gear items. The equipment items may include an item for which an endurance value is set, and an item for which an endurance value is not set. For example, for a first weapon item, an endurance value indicating the number of attacks that can be made may be set, and if attacks exceeding the endurance value are made, the first weapon item may become unable to be used. For example, the item A1 is an example of a weapon item, and an endurance value is set for the item A1.

For example, the additional items include a plurality of types of items that recover the physical strength of the player character PC, a plurality of types of items that increase the offensive strength of the player character PC, a plurality of types of items that increase the defensive strength of the player character PC, and the like. Also for each of the additional items, an endurance value (a value that decreases by using the additional item) may be set.

Each of the currency items is an item representing a common currency in the game title T series, and can be exchanged with an equipment item or an additional item. For example, a first weapon item may be able to be exchanged with a currency item having a first amount, and a second weapon item having an offensive strength greater than that of the first weapon item may be able to be exchanged with a currency item having a second amount greater than a first amount. Each currency item is not limited to money so long as the currency item is an item that can be exchanged with another item, and may be an item such as a jewel or the like.

The user operates the player character PC, thereby picking up and acquiring an item placed on the ground in the virtual space, or acquiring an item by defeating an enemy character in the virtual space. The player can save acquired items in a "pouch" up to a first predetermined number. The "pouch" is a save area of items owned by the user (the player character PC). The user can take an additional item out of the "pouch" and use the additional item during the game, or can take an equipment item out of the "pouch" and equip the player character PC with the equipment item. The user can also save an equipment item with which the player character PC is equipped in the "pouch" during the game. The first predetermined number indicating the upper limit of items that can be saved in the "pouch" may be the number of types of items, or may be the number of items of a single type, or may be the total of the number of types of items and the number of items.

The substance of the "pouch" is a storage medium directly connected to the game apparatus 20, and for example, is the non-volatile memory 23 of the game apparatus 20 or the dedicated memory card attached to the slot. The substance of the "pouch" may be a storage medium wirelessly connected to the game apparatus 20.

FIG. 5 is a diagram showing an example of a game image displayed when the game of the game title TB is executed by the game apparatus 20. In the game title TB, the game is performed using the same player character as the player character PC that appears in the game title TA.

Also in the game title TB, the user operates the player character PC and thereby can acquire an item (e.g., an item B1) in the virtual space and save the acquired item in the "pouch" up to the first predetermined number. Items in the game title TB include items common with items in the game title TA. For example, the item B1 in the game title TB is an item of the same type as the item A1 in the game title TA. The items in the game title TB include items not present in the game title TA. Conversely, the items in the game title TA may include items not present in the game title TB.

Hereinafter, a plurality of types of items in the game title TA are collectively referred to as "items A", and various types of items A are referred to as an "item A1" and an "item A2" by adding numbers. Similarly, a plurality of types of items in the game title TB are collectively referred to as "items B", and various types of items B are referred to as an "item B1" and an "item B2" by adding numbers.

As described above, during the execution of the game of the game title TA or the game title TB, the user can acquire an item and save the item in the "pouch". There are upper limits on the number of types of items and/or the number of items that can be saved in the "pouch". In the game system 1 according to an exemplary embodiment, the user can deposit an item saved in the "pouch" into the smartphone app of the smartphone 30. The user can also send a deposited item to the game apparatus 20 by operating the smartphone 30. The user can also return the deposited item to the game apparatus 20 by performing a withdrawal operation in the game apparatus 20. The deposit and the withdrawal of an item using the smartphone app are described below.

### Deposit and Withdrawal of Item

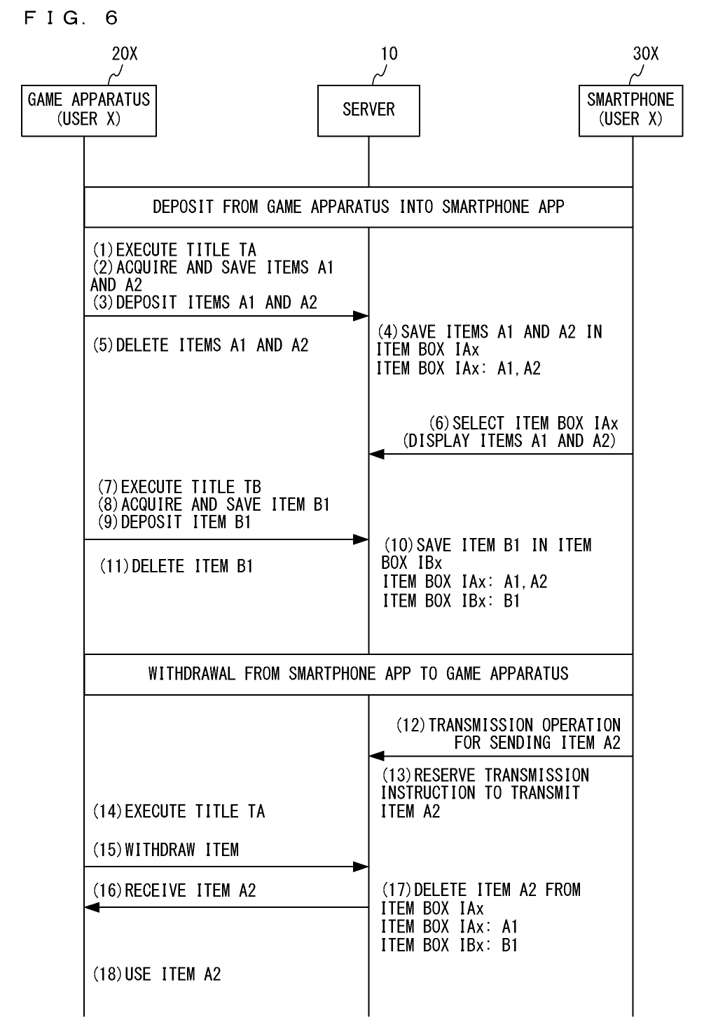

FIG. 6 is a diagram showing the flow of the deposit and the withdrawal of an item.

In the server 10, the accounts of the user X and the user Y are registered in advance. The server 10 stores data regarding each user. Specifically, the server 10 stores item boxes Ix corresponding to the user X. The item boxes Ix include an item box IAx for the game title TA and an item box IBx for the game title TB. The item box IAx is a storage area capable of saving items in the game title TA up to a second predetermined number greater than the above first predetermined number. The item box IBx is a storage area capable of saving items in the game title TB up to the second predetermined number greater than the above first predetermined number. Similarly, the server 10 stores item boxes (an item box IAy and an item box IBy) Iy corresponding to the user Y.

As shown in FIG. 6, for example, in the game apparatus 20X, the user X executes the game of the game title TA (1). The user X acquires the items A1 and A2 placed in the virtual space, by operating the player character PC. The acquired items A1 and A2 are saved in the "pouch" of the game apparatus 20X (2). In the game apparatus 20, the user X performs a deposit operation for depositing the items A1 and A2 saved in the "pouch" into the smartphone app (3).

In accordance with the deposit operation, the game apparatus 20X gives a deposit instruction to deposit the items A1 and A2 to the server 10. Specifically, the deposit instruction includes a user ID of the user X, an item ID of the item A1, and an item ID of the item A2. Each of the item IDs is information specific to the item and includes information identifying the type of the item and the game title. Even an item of the same type has a different item ID. The deposit instruction includes the item ID of each item with a thumbnail image according to the item ID. Further, if the item to be deposited has an endurance value, the deposit instruction may also include information regarding the endurance value.

The pieces of information indicating the item ID, the thumbnail image, and the endurance value may be transmitted simultaneously (through communication performed once) from the game apparatus 20X to the server 10, or may be transmitted at different timings. At least two or more of the pieces of information regarding a plurality of items may be transmitted simultaneously from the game apparatus 20X to the server 10.

In accordance with the deposit instruction from the game apparatus 20X, the server 10 saves the items A1 and A2 in the item box IAx corresponding to the user X (4). Specifically, the server 10 saves the item ID of the item A1 and the item ID of the item A2 in the item box IAx corresponding to the user X. The server 10 also saves the thumbnail image of the item A1 and the thumbnail image of the item A2 in the item box IAx. The server 10 also saves the information indicating the endurance value of the item A1.

If the items A1 and A2 are saved in the item box IAx of the server 10, the game apparatus 20X deletes the items A1 and A2 from the "pouch" (5).

If, on the other hand, the user X starts the smartphone app of the smartphone 30X and selects their box (an item box Ix), the user X can view the items A1 and A2 saved in the item box Ix (6). Specifically, the smartphone 30X acquires the item ID and the thumbnail image of the item A1 and the item ID and the thumbnail image of the item A2 from the server 10.

Similarly, in the game apparatus 20X, the user X executes the game title TB (7) and acquires the item B1 during the game of the game title TB (8). The acquired item B1 is saved in the "pouch" of the game apparatus 20X. The user X performs a deposit operation for depositing the item B1 saved in the "pouch" into the smartphone app (9). In accordance with the deposit operation, the game apparatus 20X transmits a deposit instruction to deposit the item B1 to the server 10. In accordance with the deposit instruction, an item ID of the item B1 is saved in the item box IBx of the server 10 (10), and the item B1 is deleted from the "pouch" of the game apparatus 20X (11). This results in the state where the item ID of the item A1 and the item ID of the item A2 are saved in the item box IAx of the server 10, and the item ID of the item B1 is saved in the item box IBx.

As described above, the pieces of information regarding the items A1, A2, and B1 (the pieces of information including the item IDs, the thumbnail images, and the like) saved in the game apparatus 20X are transmitted to the smartphone app via the server. The game apparatus 20X cannot directly extract information regarding the items saved in the smartphone app.

In the game apparatus 20, data indicating the shape and the external appearance of each item (three-dimensional model data and texture data) is saved in addition to the item ID and the thumbnail image. In the server 10, the item ID and the thumbnail image are saved as information regarding the item, but the data indicating the shape and the external appearance of the item are not saved. In another exemplary embodiment, the data indicating the shape and the external appearance of the item may be transmitted from the game apparatus 20 to the server 10 as information regarding the item in addition to (or instead of) the item ID and the thumbnail image and saved in the server 10.

To use an item deposited in an item box in the game apparatus 20X, the user needs to perform an operation of sending the item to the game apparatus 20 in the smartphone app and perform an operation of withdrawing the item in the game apparatus 20. The withdrawal of the item from the smartphone app to the game apparatus 20 is described below.

First, the user X performs a transmission operation for sending the item A2 saved in the item box IAx to the game apparatus 20 using the smartphone app of the smartphone 30X (12). In accordance with the transmission operation for transmitting the item A2, the smartphone 30X sends a transmission instruction to transmit the item A2 to the game apparatus 20 to the server 10. This transmission instruction includes the item ID of the item A2. The server 10 temporarily reserves the transmission instruction to transmit the item A2 (13).

Next, in the game apparatus 20X, the user X executes the game title TA again (14) and performs a withdrawal operation for withdrawing the item in the game apparatus 20X (15). In accordance with the withdrawal operation, the game apparatus 20X transmits a withdrawal instruction to the server 10. In accordance with the withdrawal instruction, the server 10 transmits the reserved item A2 to the game apparatus 20X. Specifically, the server 10 transmits the item ID of the item A2 to the game apparatus 20X. The game apparatus 20X receives the item ID of the item A2 and stores the item ID of the item A2 in the "pouch" (16). If the game apparatus 20X receives the item ID of the item A2, the server 10 deletes the item ID of the item A2 from the item box IAx (17). This results in the state where the item A1 is saved in the item box IAx of the server 10, and the item B1 is saved in the item box IBx.

As described above, the item A2 deposited in an item box (specifically, the server 10) of the smartphone app is returned to the "pouch" of the game apparatus 20X. Consequently, the game apparatus 20X can generate object data of the item A2 based on the item ID of the item A2 during the execution of the game title TA and use the item A2 in the virtual space (18).

If the user X has a plurality of game apparatuses 20X, the user X can access the server 10 using the same account from each of the plurality of game apparatuses 20X and save an item saved in an item box in any of the plurality of game apparatuses 20X. For example, the user X can perform an operation of depositing an item using a first game apparatus 20X, perform a transmission operation for transmitting the item to the game apparatuses 20 using the smartphone 30X, and perform an operation of withdrawing the item using a second game apparatus 20X.

An upper limit may be placed on the number of deposit operations during a predetermined period. For example, the number of deposit operations that can be executed (the number of items that can be deposited) in a day by the user may be limited to a predetermined number of times. On the other hand, such an upper limit may not be placed on a transmission operation for transmitting an item to the game apparatus 20 in the smartphone 30 and a withdrawal operation in the game apparatus 20. An upper limit may be placed also on a transmission instruction to the game apparatus 20 in the smartphone 30 and a withdrawal operation in the game apparatus 20.

### Movement of Item between Titles Using Smartphone App

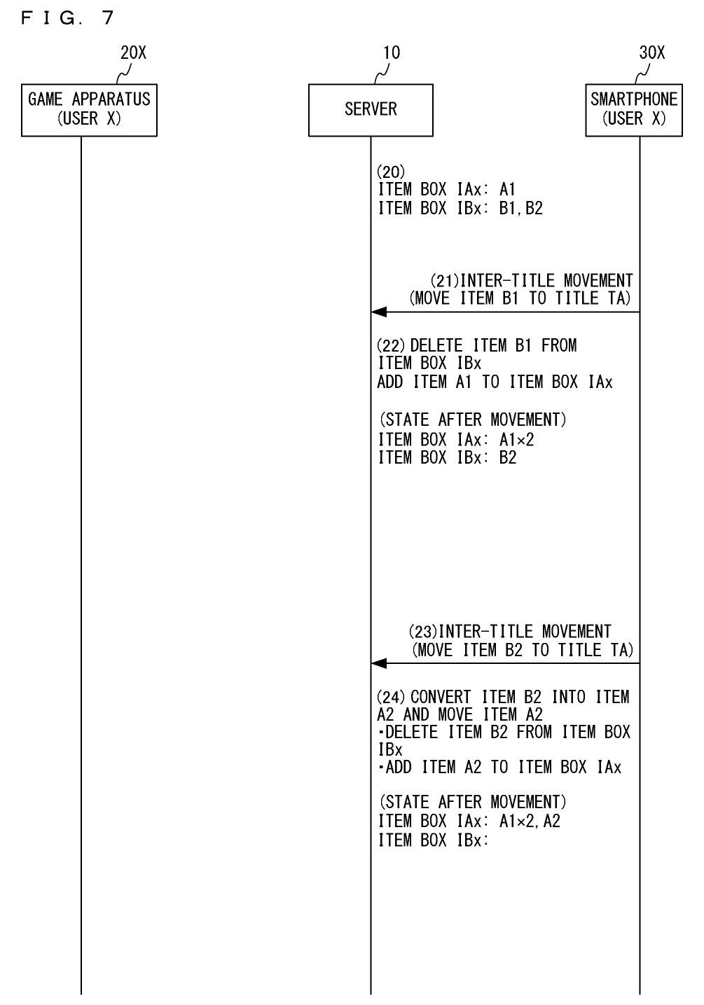

Next, the movement of an item between the game titles TA and TB using the smartphone app is described. In an exemplary embodiment, the user can move an item between the game titles TA and TB using the smartphone app. FIG. 7 is a diagram showing the flow of the movement of an item between the titles using the smartphone app. Although a case where an item is moved from the game title TB to the game title TA is described here, the same applies to a case where an item is moved from the game title TA to the game title TB.

As shown in FIG. 7, by the above deposit operation, the item A1 in the game title TA is saved in the item box IAx of the user X, and the items B1 and B2 in the game title TB are saved in the item box IBx (20).

The user X performs an inter-title movement operation using the smartphone app of the smartphone 30X (21). Specifically, the user X selects their item box, specifies an item to be moved in the item box, and performs a determination operation. Here, the user X performs an inter-title movement operation for moving the item B1 from the game title TB to the game title TA. In accordance with the determination operation, the smartphone 30X transmits an inter-title movement instruction to the server 10.

Here, the game title TB includes an item present in the game title TA and an item not present in the game title TA. For example, the item B1 is an item of the same type as the item A1 in the game title TA and has an endurance value similarly to the item A1.

In this case, in accordance with the inter-title movement instruction, the server 10 deletes the item B1 from the item box IBx and adds the item A1 of the same type as the item B1 to the item box IAx (22). Specifically, in accordance with the inter-title movement instruction, the server 10 deletes the item ID of the item B1 from the item box IBx and adds the item ID of the item A1 to the item box IAx. The server 10 also sets an endurance value corresponding to the endurance value of the item A1 for the item B1. This results in the state where the item IDs of the two items A1 are saved in the item box IAx, and the item ID of the single item B2 is saved in the item box IBx.

Similarly, the user X performs an inter-title movement operation for moving the item B2 saved in the item box IBx to the game title TA using the smartphone app of the smartphone 30X (23). In accordance with the inter-title movement operation, the smartphone 30X gives an inter-title movement instruction to the server 10.

Here, the item B2 is an item not present in the game title TA. In the server 10, a conversion rule is set that defines into which item in the game title TA an item in the game title TB is to be converted. The server 10 converts an item in accordance with the conversion rule and moves the item to the game title TA. For example, the server 10 converts the item B2 into the item A2 set in advance of a different type and moves the item A2 (24).

Specifically, in accordance with the inter-title movement instruction, the server 10 deletes the item ID of the item B2 from the item box IBx, converts the item B2 into the item A2, and adds the item ID of the item A2 to the item box IAx. This results in the state where the two items A1 and the single item A2 are saved in the item box IAx, and no item is saved in the item box IBx.

As described above, the user X can move an item between the game titles TA and TB using the smartphone app. The user X can return an item moved from the game title TB to the game title TA to the game apparatus 20 and use the item by performing a withdrawal operation in the smartphone app as described above.

If an item to be moved is present in a game title at the movement destination, the item is not converted, and an item of the same type corresponding to the game title at the movement destination is added to an item box. If, on the other hand, an item to be moved is not present in a game title at the movement destination, the item is converted.

For example, a first equipment item in the game title TB may be converted into a currency item having a first amount and moved to the game title TA, and a second equipment item in the game title TB may be converted into a currency item having a second amount and moved to the game title TA. A third equipment item in the game title TB may be converted into a fourth equipment item of a different type (or an additional item) and moved to the game title TA.

In the game title TB, there is a function of forming a single item by combining a plurality of types of items in accordance with an operation of the user. For example, the user can form an item B12 by combining the item B1 and the item B2 during the execution of the game of the game title TB. The item B12 saved in the pouch is saved in the item box IBx by a deposit operation of the user X. Specifically, an item ID, a thumbnail image, and an endurance value of the item B12 are saved in the item box IBx. The item ID of the item B12 includes the item ID of the item B1 and the item ID of the item B2.

On the other hand, in the game title TA, there is not a function of forming a single item by combining a plurality of types of items. If the item B12 saved in the item box IBx is selected, and an inter-title movement operation is performed, the item B12 is broken down into the two items B1 and B2, and the broken-down items B1 and B2 are further converted into the items A1 and A2, and the items A1 and A2 are moved to the item box IAx. Specifically, the server 10 breaks down the item ID of the item B12 into the item ID of the item B1 and the item ID of the item B2, converts the items B1 and B2 into the items A1 and A2, and adds the item ID of the item A1 and the item ID of the item A2 to the item box IAx.

Similarly to the above, if an item corresponding to the item B1 or the item B2 is not present in the game title TA, the item B1 or the item B2 may be converted into a currency item that can be used in the game title TB or an item of a different type (e.g., an equipment item or an additional item).

In an exemplary embodiment, an upper limit is placed on the number of inter-title movements during a predetermined period. Specifically, during the predetermined period, the total number of times of the number of movements from the game title TA to the game title TB and the number of movements from the game title TB to the game title TA is limited to a predetermined number of times. For example, the number of inter-title movements that can be executed (the number of items that can be moved between titles) in a day by the user is limited to a predetermined number of times.

In a case where such a limitation is not placed, and for example, if the user owns many advantageous items in the game title TA, the user can unlimitedly move items in the game title TA to the game title TB during the game of the game title TB. In this case, the user may be able to unlimitedly use items without acquiring items in the virtual space during the game of the game title TB, and the balance of the game may collapse. In a case where an item is moved between game titles, the item may be converted into a different item. Thus, in a case where inter-title movement can be unlimitedly made, a bias may occur in items owned by the user, and the balance of the game may collapse. In an exemplary embodiment, an upper limit is placed on the number of inter-title movements during a predetermined period, and therefore, it is possible to prevent such an imbalance of the game.

An upper limit may be placed on either one of the number of movements from the game title TA to the game title TB and the number of movements from the game title TB to the game title TA.

### Sharing of Item Box

Next, the sharing of an item box with another user is described. In an exemplary embodiment, the user can share their item box stored in the server 10 with another user. Hereinafter, an item box Ix of the user X shared by the user X is referred to as a "share box Sx", and an item box Iy of the user Y shared by the user Y is referred to as a "share box Sy".

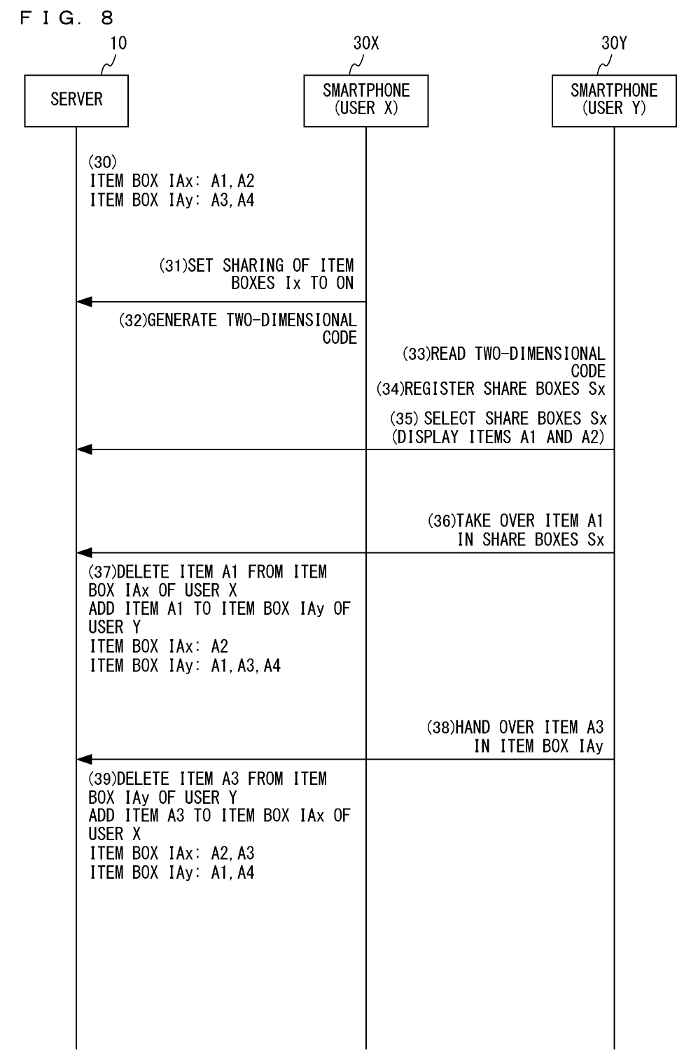

FIG. 8 is a diagram showing the flow of the handing over and the taking over of an item between users using share boxes. Although in FIG. 8, a case is described where items A in the game title TA are handed over and taken over between users, the same applies to a case where items B in the game title TB are handed over and taken over between users.

As shown in FIG. 8, by the above deposit operation, the items A1 and A2 are saved in the item box IAx of the user X, and items A3 and A4 are saved in the item box IAy of the user Y (30).

The user X sets the sharing of the item boxes Ix to ON using the smartphone app of the smartphone 30X (31). If the sharing is set to ON, items in the item boxes IAx and IBx are shared with another user. The user may set whether or not to permit the sharing of each item in their item boxes.

If the user X sets the sharing of the item boxes Ix to ON, the smartphone 30X generates a two-dimensional code for the other user to access the item boxes Ix (32). Specifically, in accordance with the setting of the sharing of the item boxes Ix to ON, the server 10 makes a setting so that the other user can access the item boxes Ix, and also generates information for accessing the item boxes Ix. As the information for accessing the item boxes Ix, for example, the server 10 generates a URL (Uniform Resource Locator). The server 10 transmits the generated URL to the smartphone 30X. Then, the smartphone 30X generates a two-dimensional code (an image) according to the URL. The user X can set a password for the item boxes Ix to prevent access from an unspecified user. The server 10 may generate a two-dimensional code, and the smartphone 30X may receive and display the two-dimensional code. The smartphone 30X may generate a URL, and the server may receive the URL.

The smartphone 30Y reads the two-dimensional code generated by the smartphone 30X (33). For example, the smartphone 30Y may capture the two-dimensional code displayed on the display 36 of the smartphone 30X using the camera 37, thereby reading the two-dimensional code. Alternatively, for example, the smartphone 30Y may read the two-dimensional code uploaded to an SNS (social network service) by the user X, using an SNS app.

If the smartphone 30Y reads the two-dimensional code, the smartphone 30Y registers the item boxes Ix shared with the user X as share boxes Sx in the smartphone app (34). Specifically, the smartphone 30Y stores the URL indicated by the two-dimensional code in association with the share boxes Sx. Each smartphone 30 can store share boxes shared with another user up to a predetermined number (e.g., five).

If the user Y selects the share boxes Sx, the items A1 and A2 saved in the share boxes Sx are displayed on the smartphone 30Y (35). Specifically, the smartphone 30Y accesses the server 10 based on the URL corresponding to the share boxes Sx and receives the item IDs of the items saved in the item box IAx of the user X with the thumbnail images.

Next, in the smartphone 30Y, the user Y performs a taking-over operation for taking over the item A1 in the share boxes Sx of the user X (36). In accordance with the taking-over operation, the smartphone 30Y transmits to the server 10 a taking-over instruction to move the item A1 from the share boxes Sx to the item box IAy.

In accordance with the taking-over instruction, the server 10 deletes the item ID of the item A1 from the item box IAx of the user X and adds the item ID of the item A1 to the item box IAy of the user Y (37). In this case, the thumbnail image of the item A1 is also saved in the item box IAy. The endurance value of the item A1 saved in the item box IAx is also saved in the item box IAy. This results in the state where the item ID of the item A2 is saved in the item box IAx, and the item IDs of the items A1, A3, and A4 are saved in the item box IAy.

Next, in the smartphone 30Y, the user Y performs a handing-over operation for handing over the item A3 in the item box IAy of the user Y to the user X (38). In accordance with the handing-over operation, the smartphone 30Y transmits to the server 10 a handing-over instruction to hand over the item A3 to the user X.

In accordance with the handing-over instruction, the server 10 deletes the item ID of the item A3 from the item box IAy of the user Y and adds the item ID of the item A3 to the item box IAx of the user X (39). This results in the state where the item IDs of the items A2 and A3 are saved in the item box IAx, and the item IDs of the items A1 and A4 are saved in the item box IAy.

As described above, each user can share their item box or register an item box shared with another person as a share box. Consequently, each user can hand over their item to another user or take over an item from another user.

In an exemplary embodiment, an upper limit is placed on the number of times of the handing over and/or the taking over of an item (the number of items that can be handed over or taken over) during a predetermined period. For example, the number of times a taking-over operation that can be executed (the number of items that can be taken over) in a day by the user is limited to a predetermined number of times. In a case where such a limitation is not placed, the user may be able to unlimitedly take over items from another user without acquiring items in the virtual space during the game, and the balance of the game may collapse. In an exemplary embodiment, an upper limit is placed on the number of times of an handing-over operation and/or a taking-over operation on an item during a predetermined period, and therefore, it is possible to prevent such an imbalance of the game.

### Examples of Screens on Smartphone

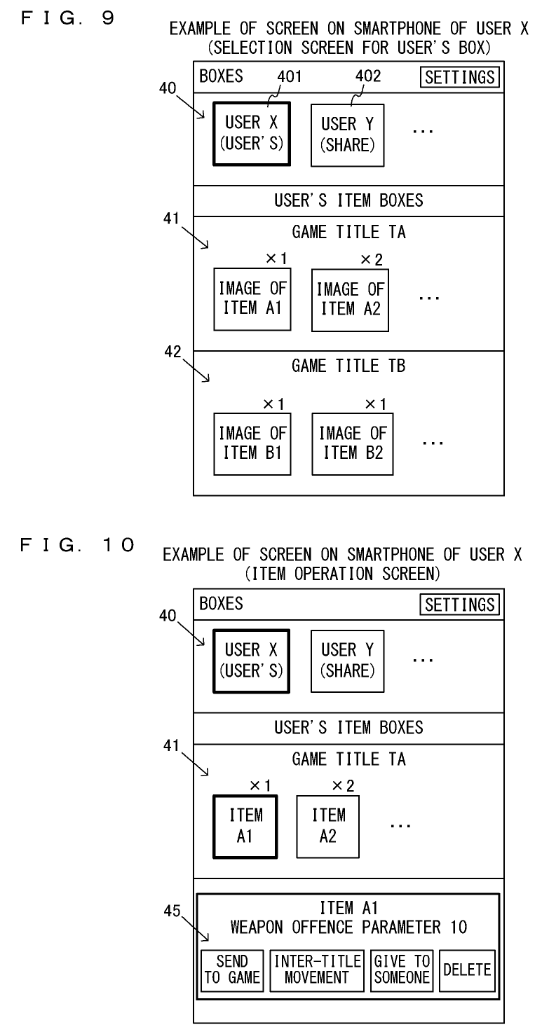

Next, examples of screens on each smartphone 30 are described. FIG. 9 is a diagram showing an example of a screen on the smartphone 30X and is a diagram showing an example of a screen displayed when the user's box is selected. FIG. 10 is a diagram showing an example of a screen on the smartphone 30X and is a diagram showing an example of an item operation screen displayed when the item A1 in the game title TA is selected.

As shown in FIG. 9, in a screen on the smartphone 30X, a box display area 40 is provided. The box display area 40 displays an icon 401 indicating the user's boxes (the item boxes Ix of the user X). The box display area 40 also displays an icon 402 indicating the share boxes Sy (the item boxes Iy of the user Y) shared with the user Y and registered by the user X. In addition to these icons, icons indicating share boxes of a plurality of other users are displayed.

If the icon 401 indicating the user's box is selected, items saved in the item boxes Ix are displayed in item list display areas 41 and 42. For example, the item list display area 41 displays the thumbnail images of the items A1 and A2 saved in the item box IAx. The item list display area 42 displays the thumbnail images of the items B1 and B2 saved in the item box IBx. Above each thumbnail image, the number of saved items is displayed. In FIG. 9, for example, if the thumbnail image of the item A1 is selected, an item operation screen shown in FIG. 10 is displayed.

As shown in FIG. 10, if the thumbnail image of the item A1 is selected, an item UI (user interface) 45 appears, and the item UI 45 displays detailed information regarding the item A1 and a plurality of operation buttons indicating operations on the selected item A1.

If a "send to game" button is operated, the selected item A1 is sent to the game apparatus 20. The operation on the "send to game" button is an example of a transmission operation for sending the item A1 saved in the item box IAx to the game apparatus 20X. If the "send to game" button is operated, the smartphone 30X transmits to the server 10 a transmission instruction to transmit the item A1. The server 10 temporarily reserves the transmission instruction.

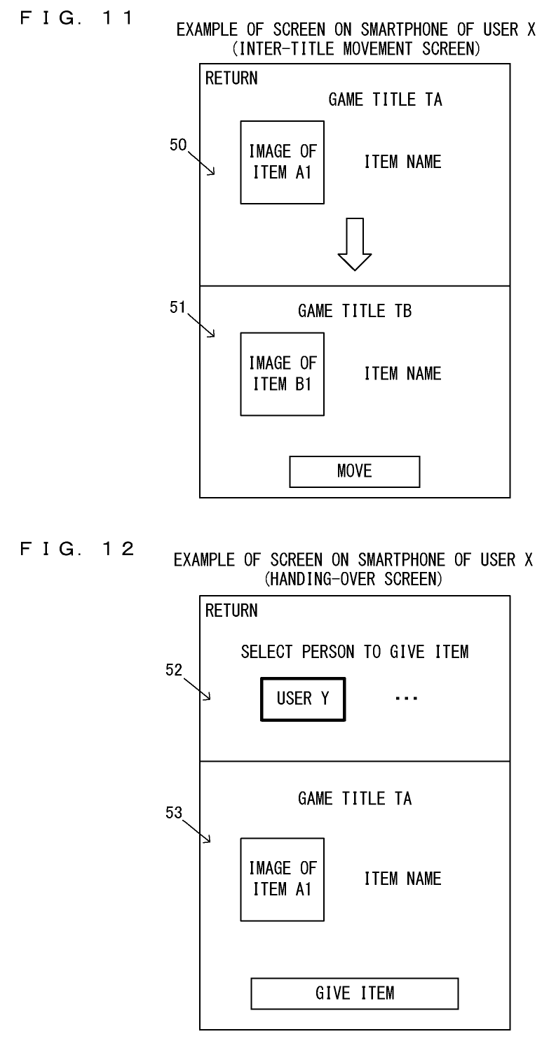

If an "inter-title movement" button is operated, the item A1 in the game title TA is moved to the game title TB. FIG. 11 is a diagram showing an example of an inter-title movement screen displayed in a case where the "inter-title movement" button is operated on the item operation screen in FIG. 10.

As shown in FIG. 11, a display area 50 on the upper side displays the game title TA as a movement source and the thumbnail image and the item name of the item A1 at the movement source. A display area 51 on the lower side displays the game title TB as a movement destination and the thumbnail image and the item name of the item B1 at a movement destination.

The item A1 in the game title TA and the item B1 in the game title TB are items of the same type, and therefore, the types of the items are not converted by the inter-title movement. Thus, the thumbnail image and the item name displayed in the display area 50 on the upper side and the thumbnail image and the item name displayed in the display area 51 on the lower side are the same as each other. If the types of the items are converted by the inter-title movement, the thumbnail image and the item name displayed in the display area 51 on the lower side are different from the thumbnail image and the item name displayed in the display area 50 on the upper side.

If a "move" button is operated on the inter-title movement screen in FIG. 11, a single item A1 is moved from the game title TA to the game title TB. The operation on the "move" button is an example of an inter-title movement operation for moving the item A1 to the game title TB. Specifically, the item ID of the item A1 in the item box IAx is deleted, and the item ID of the item B1 is added into the item box IBx. At this time, the same endurance value as the endurance value of the item A1 is set for the item B1. The user may be able to select a plurality of items and move the selected plurality of items to another game title at a time. If the number of inter-title movements of items (the number of items that can be moved between titles) during a predetermined period (e.g., in a day) reaches the upper limit, display indicating that an item cannot be moved may be performed.

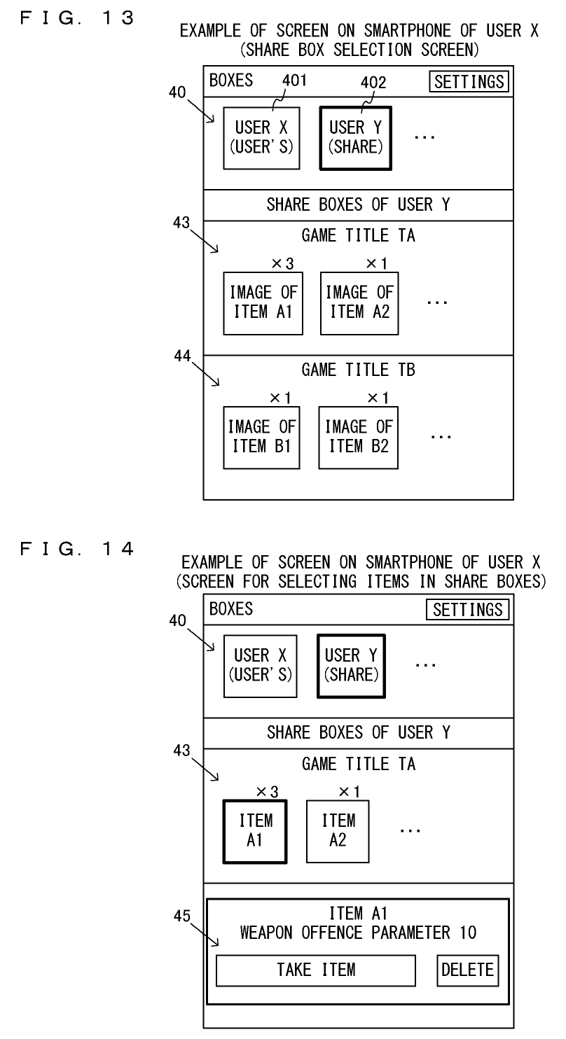

Referring back to FIG. 10, if a "give to someone" button is operated, the item A1 is handed over to another user. FIG. 12 is a diagram showing an example of an item handing-over screen displayed in a case where the "give to someone" button is operated on the item operation screen in FIG. 10.

As shown in FIG. 12, a display area 52 on the upper side displays the user name of another user corresponding to the share boxes registered by the user X. A display area 53 on the lower side displays the thumbnail image and the item name of the selected item A1. For example, if the user X selects the user Y in the display area 52 on the upper side and operates a "give item" button, a single item A1 is transmitted to the user Y. The operation on the "give item" button is an example of a handing-over operation for the user X to send the item A1 to the user Y. Specifically, in accordance with the operation on the "give item" button, the item A1 is deleted from the item box IAx of the user X, and the item A1 is added to the item box IAy of the user Y. The user may be able to select a plurality of items in their item boxes and hand over the plurality of items to another user at a time. If the number of times of the handing over of items (the number of items that are handed over) during a predetermined period (e.g., in a day) reaches the upper limit, display indicating that an item cannot be handed over may be performed.

Referring back to FIG. 10, if a "delete" button is operated, the item A1 is deleted from the item box IAx.

If, on the other hand, a "settings" button at the upper right of the screen in FIG. 10 is operated, a screen for making various settings is displayed. For example, a screen for setting the sharing of the item boxes to ON or OFF and setting a password is displayed. If the "settings" button is operated, a screen for displaying a two-dimensional code corresponding to the user's item boxes and transmitting the two-dimensional code to another user via a network (e.g., an SNS) is displayed. If the "settings" button is operated, to register share boxes of another user, a screen for reading a two-dimensional code corresponding to item boxes of the other user is displayed.

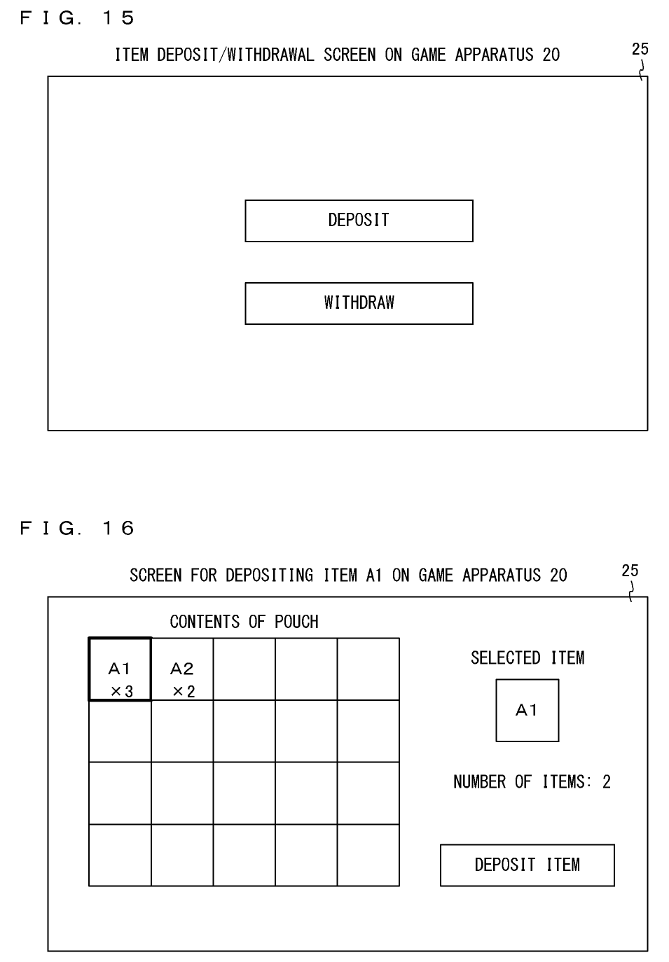

FIG. 13 is a diagram showing an example of a screen on the smartphone 30X and is a diagram showing an example of a screen displayed when the share boxes Sy of the user Y are selected. FIG. 14 is a diagram showing an example of a screen on the smartphone 30X and is a diagram showing an example of a screen displayed when the item A1 in the share boxes Sy is selected.

As shown in FIG. 13, if an icon indicating the share boxes Sy is selected, items saved in the item boxes Iy of the server 10 are displayed in item list display areas 43 and 44. Specifically, the item list display area 43 displays the thumbnail images of the items A1 and A2 saved in the item box IAy of the user Y. The item list display area 44 displays the thumbnail images of the items B1 and B2 saved in the item box IBy of the user Y. In FIG. 13, for example, if the thumbnail image of the item A1 is selected, a screen shown in FIG. 14 is displayed.

As shown in FIG. 14, if the thumbnail image of the item A1 is selected, the item UI 45 appears, and the item UI 45 displays detailed information regarding the item A1 and a plurality of operation buttons indicating operations on the selected item A1.

If a "take item" button is operated, a single item A1 in the item box IAy of the user Y is sent to the item boxes Ix of the user X. The operation on the "take item" button is an example of a taking-over operation for taking over the item A1 from the user Y. Specifically, in accordance with the operation on the "take item" button, the item A1 is deleted from the item box IAy of the user Y, and the item A1 is added to the item box IAx of the user X. The user may be able to select a plurality of items in the share boxes and transmit the plurality of items to their item boxes at a time. If the number of times of the taking over of items (the number of items that are taken over) during a predetermined period (e.g., in a day) reaches the upper limit, display indicating that an item cannot be taken over may be performed.

If the "delete" button is operated, a single item A1 is deleted from the item box IAy of the user Y.

### Examples of Screens on Game Apparatus

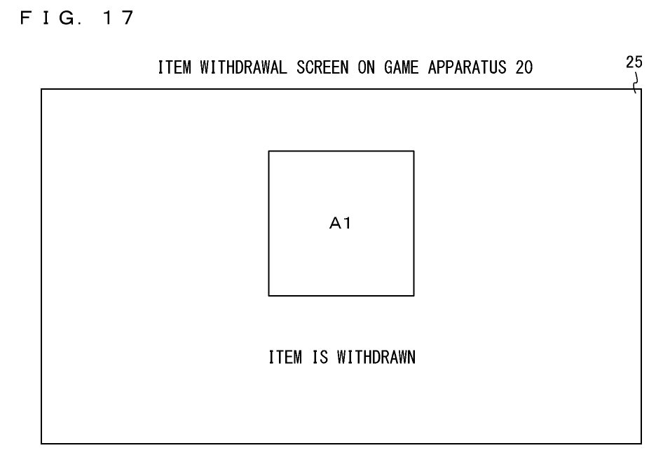

Next, examples of screens on each game apparatus 20 are described. FIG. 15 is a diagram showing an example of a screen for depositing or withdrawing an item in the game apparatus 20.

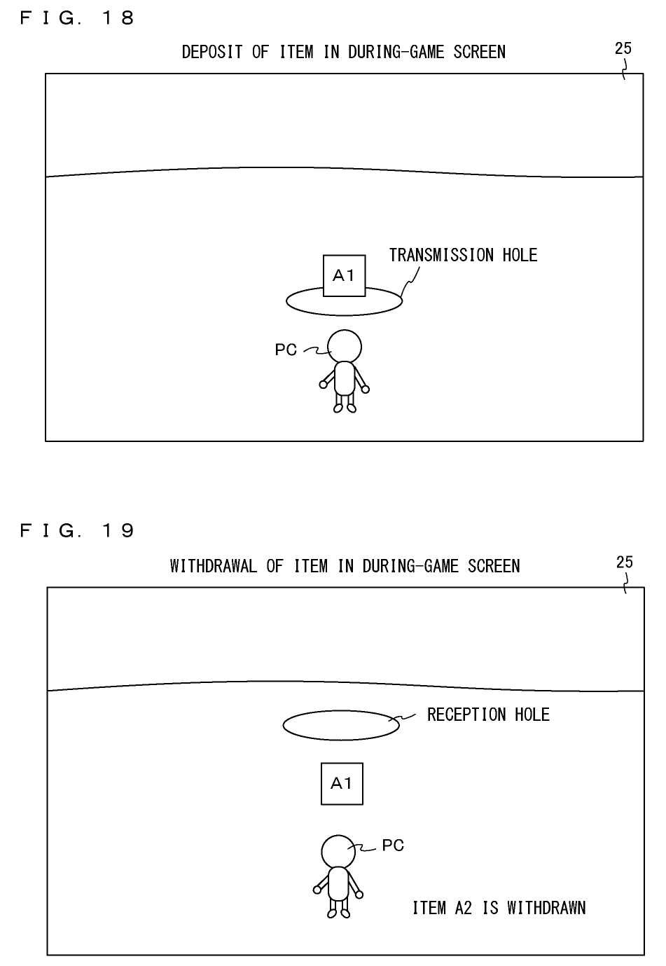

For example, if a predetermined operation is performed on a during-game screen (the screen in FIG. 4 or 5) where the player character PC placed in the virtual space is displayed, the during-game screen switches to an item deposit/withdrawal screen. For example, as shown in FIG. 15, a "deposit" button and a "withdraw" button are displayed. If the "deposit" button is operated in FIG. 15, a screen shown in FIG. 16 is displayed.

FIG. 16 is a diagram showing an example of an item deposit screen displayed on the game apparatus 20.

The item deposit screen displays a list of items saved in the pouch (the game apparatus 20). For example, in FIG. 16, the thumbnail images of the items A1 and A2 are displayed in two squares among 16 squares. This indicates that two types of items A1 and A2 are saved in the pouch, and the remaining 14 squares are vacant. A number displayed in a superimposed manner on each thumbnail image indicates the number of saved items. On the screen in FIG. 16, for example, the user selects the item A1, specifies "2" as the number of items A1, and operates a "deposit item" button. The operation on the "deposit item" button is an example of a deposit operation for depositing the two items A1. Specifically, if the "deposit item" button is operated, the game apparatus 20 transmits the item IDs of the two items A1 and the thumbnail image of the items A1 to the server 10. The endurance values of the items A1 are also transmitted. The server 10 receives the two item IDs indicating the items A1 and the endurance values and the thumbnail image of the respective items A1 and saves the item IDs, the endurance values, and the thumbnail image in the item box IAx. If the saving of the item IDs, the endurance values, and the thumbnail image in the item box IAx is completed, the game apparatus 20 deletes the two items A1 from the pouch. Specifically, the game apparatus 20 stores information indicating the types of items and information indicating the number of items of each type and decreases the number of items A1 by "2".

If, on the other hand, the "withdraw" button is selected on the screen in FIG. 15, there is a case where a screen shown in FIG. 17 is displayed. FIG. 17 is a diagram showing an example of an item withdrawal screen. Specifically, if the "withdraw" button is selected in FIG. 15, the game apparatus 20 accesses the server 10 and attempts to withdraw an item from an item box. For example, if a transmission instruction to transmit the item A1 is reserved in the server 10, the game apparatus 20 receives the item ID of the item A1 from the server 10 and displays the screen shown in FIG. 17. If a transmission instruction to transmit an item is not reserved in the server 10, the game apparatus 20 may perform display indicating that a transmission instruction to transmit an item is not given.

An item may be deposited and withdrawn on a during-game screen.

FIG. 18 is a diagram showing the state where an item is deposited on a during-game screen. For example, if the user performs a predetermined operation for depositing an item on the during-game screen shown in FIG. 18, a transmission hole appears in the virtual space, and the item is put into the transmission hole. An item may be deposited on a during-game screen as described above. If the user performs a predetermined operation, a UI for selecting an item may be displayed, and an item selected on the UI may be put into the transmission hole. If the user performs a predetermined operation on a during-game screen, a transmission hole may appear in the virtual space. If an item deposit operation is performed when the player character PC is located within a predetermined distance from the transmission hole, an item may be put into the transmission hole, and the item may be deposited.

FIG. 19 is a diagram showing the state where an item is withdrawn on a during-game screen. For example, if the user performs a predetermined operation for withdrawing an item on the during-game screen as shown in FIG. 19, a reception hole appears in the virtual space. For example, if a transmission instruction to transmit the item A1 is reserved in the server 10, the item A1 appears from the reception hole. An item may be withdrawn on a during-game screen as described above. The transmission hole for depositing an item and the reception hole for withdrawing an item may be the same as each other.

As described above, in the game system 1 according to an exemplary embodiment, the user can deposit an item into an item box from the game apparatus 20 or withdraw a deposited item from an item box to the game apparatus 20. The number of items that can be deposited into an item box (the number of types of items, the number of items with respect to each type of item, or the total number of all items) is greater than the number of items that can be saved in the game apparatus 20. As described above, the user can save an item acquired during the game in an item box different from the game apparatus 20. Thus, the user can acquire more items and use the items for the game.

In an exemplary embodiment, it is possible to move an item saved in an item box between game titles. Consequently, for example, it is possible to use an extra item in the game title TA in the game title TB. Moreover, for example, if the game title TB is released after the game title TA, it is possible to hand over an item used in the game title TA, which is a past work, to the game title TB, which is a new work. Consequently, it is possible to utilize an item acquired in the game title TA in the game title TB.

In an exemplary embodiment, a user can share an item box with another user and hand over an item to the other user or take over an item from the other user. Consequently, users can exchange items with each other and use the exchanged items in the game.

### Details of Processing in Game System

Next, the details of processing in the game system 1 are described. First, data stored in the apparatuses included in the game system 1 is described.

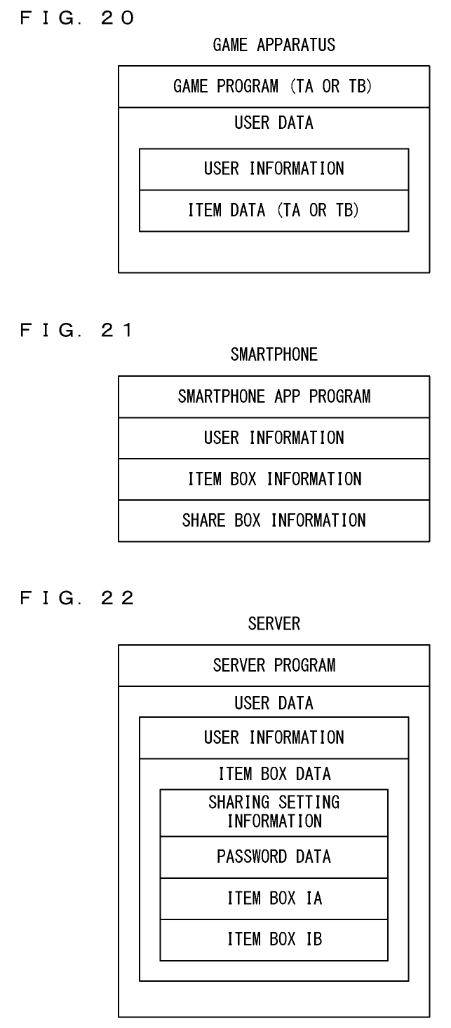

FIG. 20 is a diagram showing examples of various pieces of data stored in each game apparatus 20. As shown in FIG. 20, a memory (e.g., the DRAM 22, a dedicated memory card attached to the slot, or the non-volatile memory 23) of the game apparatus 20 stores a game program and user data.

The game program includes instructions for executing a game apparatus process (described below) executed by the game apparatus 20. The game program is stored in advance in the dedicated memory card or the non-volatile memory 23 and is loaded into the DRAM 22 when the game is executed. For example, if the dedicated memory card for the game title TA is attached to the game apparatus 20, the game program for the game title TA is read into the DRAM 22 and executed. If the dedicated memory card for the game title TB is attached to the game apparatus 20, the game program for the game title TB is read into the DRAM 22 and executed.

The user data is data regarding the user of the game apparatus 20 and includes user information and item data. The user information includes a user ID identifying the user, a user name, a password, and the like. The item data is data regarding an item acquired by the user (the player character PC) during the game and is data regarding the types and the number of items owned by the user. For example, item data of the game title TA is saved in the dedicated memory card for the game title TA or the non-volatile memory 23. Item data of the game title TB is saved in the dedicated memory card for the game title TB or the non-volatile memory 23.

FIG. 21 is a diagram showing examples of various pieces of data stored in each smartphone 30. As shown in FIG. 21, the smartphone 30 stores a smartphone app program, user information, item box information, and share box information.

The smartphone app program includes instructions for executing a smartphone process (described below) executed by the smartphone 30. The smartphone app program is downloaded from the Internet and installed on the smartphone 30.

The user information includes a user ID identifying the user, a user name, a password, and the like.

The item box information is information regarding item boxes of the user of the smartphone 30, and for example, may include the URL of the item boxes of the user. The item box information may include information indicating an item ID, a thumbnail image, and an endurance value of each item stored in the item boxes.

The share box information is information regarding share boxes (the item boxes of another user) registered by the user, and for example, may include the URL of the item boxes of another user. The share box information may include information indicating an item ID, a thumbnail image, and an endurance value of each item stored in the share boxes.

FIG. 22 is a diagram showing examples of various pieces of data stored in the server 10. As shown in FIG. 22, the server 10 stores a server program and user data.

The server program includes instructions for executing a server process (described below) executed by the server 10.

The user data is data regarding each user. The user data includes user information and item box data with respect to each user. The user information includes a user ID identifying the user, a user name, a password, and the like.

The item box data is data regarding item boxes corresponding to the user. The item box data includes sharing setting information indicating whether or not the item boxes are shared, and password data regarding a password applied to the item boxes. The item box data also includes an item box IA for saving items A in the game title TA and an item box IB for saving items B in the game title TB. The item box IA stores information indicating an item ID of each item A, an endurance value of each item A, and a thumbnail image of each item A. The item box IB stores information indicating an item ID of each item B, an endurance value of each item B, and a thumbnail image of each item B.

### Game Apparatus Process

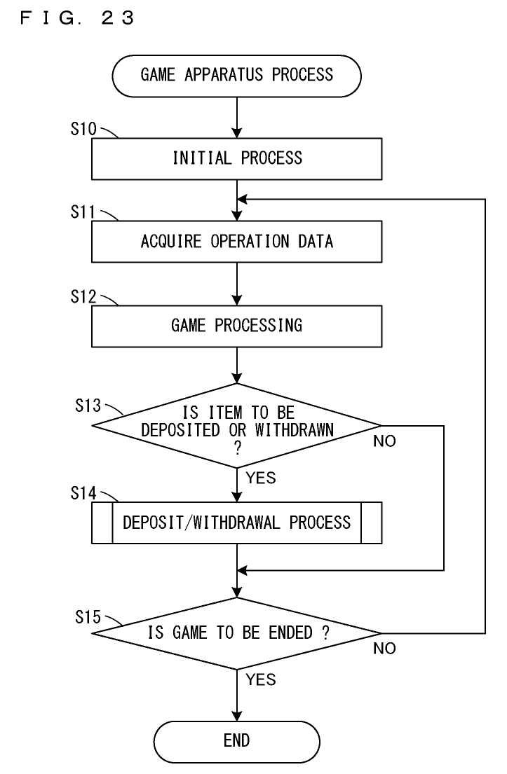

Next, a game apparatus process performed by each game apparatus 20 is described. FIG. 23 is a flow chart showing an example of the game apparatus process performed by the game apparatus 20. The game apparatus process is started if the user gives an instruction to start the game of the game title TA or TB. A description is given below of a case where the game of the game title TA or TB is performed by the game apparatus 20X of the user X.

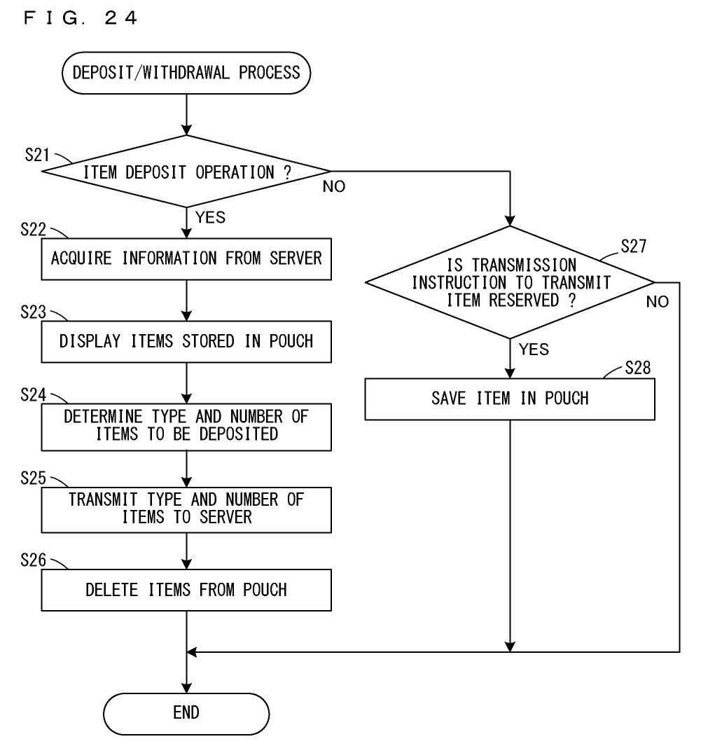

In an exemplary embodiment, the description is given on the assumption that the processes of steps shown in FIGS. 23 and 24 are executed by the processor 21 of the game apparatus 20 executing the game program using a memory (e.g., the DRAM 22). In another exemplary embodiment, however, some of the processes of the steps may be executed by a processor (e.g., a dedicated circuit or the like) different from the processor 21. Some of the processes of the steps may be executed by another information processing apparatus (e.g., a server). The processes of the steps are merely illustrative. Thus, the processing order of the steps may be changed, or another process may be performed in addition to (or instead of) the processes of the steps, so long as similar results are obtained.

As shown in FIG. 23, the processor 21 performs an initial process for starting the game (step S10). In the initial process, various pieces of data necessary for the game are read and set. For example, in the initial process, the processor 21 acquires item data stored in the "pouch" (e.g., the dedicated memory card or the non-volatile memory 23) corresponding to the user X. If a plurality of users are registered in the game apparatus 20, any of the plurality of users is selected based on an operation input of the user, and data item corresponding to the selected user is read. If the initial process ends, the game is started.

If the game is started, the processor 21 acquires operation data from the controller (step S11).

Next, the processor 21 performs game processing (step S12). Here, based on the operation data, the processor 21 performs the process of moving the player character PC in the virtual space, the process of causing the player character PC to acquire an item, the process of equipping the player character PC with an owned item or using an owned item, or the like. For example, if the player character PC picks up an item placed on the ground in the virtual space, the processor 21 saves the item ID of the item in the "pouch" and deletes the item from the virtual space. For example, if an operation for equipping the player character PC with an equipment item (e.g., a weapon item) saved in the "pouch" is performed, the processor 21 equips the player character PC with the equipment item and deletes the equipment item from the "pouch". Specifically, the processor 21 deletes an item ID saved in the "pouch", generates an equipment item corresponding to the item ID in the virtual space, and equips the player character PC with the equipment item. When the player character PC is equipped with an equipment item and if an operation for decreasing the endurance value of the equipment item (e.g., an attack using a weapon item with which the player character PC is equipped) is performed, the processor 21 decreases the endurance value of the equipment item. If the endurance value of the equipment item becomes less than or equal to a value set in advance, the processor 21 deletes the equipment item. The processor 21 generates a game image according to the results of these processes and displays the game image on a display. The processes of steps S11 and S12 are repeatedly executed at predetermined frame time intervals (e.g., 1/60-second intervals), whereby the game progresses.

Next, based on the operation data, the processor 21 determines whether or not to deposit or withdraw an item (step S13). Here, the processor 21 determines whether or not an item deposit operation or an item withdrawal operation is performed.

If it is determined that an item is to be deposited or withdrawn (step S13: YES), the processor 21 performs an item deposit/withdrawal process (step S14). The details of the deposit/withdrawal process will be described below.

If the determination is NO in step S13, or if the process of step S14 is executed, the processor 21 determines whether or not to end the game (step S15). For example, if the user gives an instruction to end the game, the processor 21 ends the game. If the determination is NO in step S15, the processor 21 executes the process of step S11 again.

### Item Deposit/Withdrawal Process

Next, the details of the item deposit/withdrawal process are described. FIG. 24 is a flow chart showing an example of the item deposit/withdrawal process in step S14.

As shown in FIG. 24, the processor 21 determines whether or not an item deposit operation is performed (step S21).

If an item deposit operation is performed (step S21: YES), the processor 21 acquires information from the server 10 (step S22). Here, the processor 21 accesses the server 10 and acquires information regarding the content, the number of vacancies, and the like of the item boxes Ix of the user X.

Next, the processor 21 displays a list of items stored in the pouch (step S23). For example, if the game title TA is being executed, the processor 21 displays a list of items in the game title TA of the user X stored in the dedicated memory card or the non-volatile memory 23. If the game title TB is being executed, the processor 21 displays a list of items in the game title TB of the user X stored in the dedicated memory card or the non-volatile memory 23.

Next, the processor 21 receives an operation from the user and determines the type and the number of items to be deposited into the smartphone app in the displayed list of items (step S24).

Next, the processor 21 transmits the type and the number of items determined in step S24 to the server 10 (step S25). Specifically, the processor 21 transmits the item IDs of the determined items, the endurance values of the items, and the thumbnail images of the items to the server 10. In a case where a plurality of items of the same type are transmitted, the processor 21 transmits a plurality of item IDs indicating the items of the same type to the server 10. If the item boxes Ix do not have a vacancy, the processor 21 performs display indicating that no more items can be deposited. Then, the process shown in FIG. 24 ends.

If the deposit of the determined items is successful, the processor 21 deletes the items from the pouch (step S26). If a plurality of items of the same type are transmitted, the processor 21 decreases the number of owned items of this type stored in the pouch by the number of the transmitted items.

If, on the other hand, an item deposit operation is not performed (step S21: NO), the processor 21 determines that an item withdrawal operation is performed. Next, the process of step S27 is executed.

In step S27, the processor 21 accesses the server 10 and determines whether or not a transmission instruction to transmit an item is reserved. In an item box process described below, if a transmission instruction to transmit an item is transmitted from the smartphone 30X to the server 10, the transmission instruction is reserved in the server 10.

If a transmission instruction to transmit an item is reserved in the server 10 (step S27: YES), the processor 21 receives an item from the server 10 and saves the item in the pouch (step S28). The processor 21 also receives the endurance value of the item from the server 10 and stores the endurance value of the item. If a transmission instruction to transmit a plurality of items is reserved, the processor 21 receives the plurality of items from the server 10 and saves the plurality of items in the pouch. If an item of the same type as the received item is saved in the pouch, the processor 21 increases the number of owned items of this type by the number of the received items. If the game apparatus 20X receives an item, the item is deleted from the item boxes Ix of the server 10. If the pouch does not have a vacancy, i.e., if the number of items currently saved in the pouch reaches the upper limit, the processor 21 displays indicating that the upper limit is reached. Then, the process shown in FIG. 24 ends.

If the process of step S26 is performed, or if the determination is NO in step S27, or if the process of step S28 is performed, the processor 21 ends the process shown in FIG. 24.

### Smartphone Process

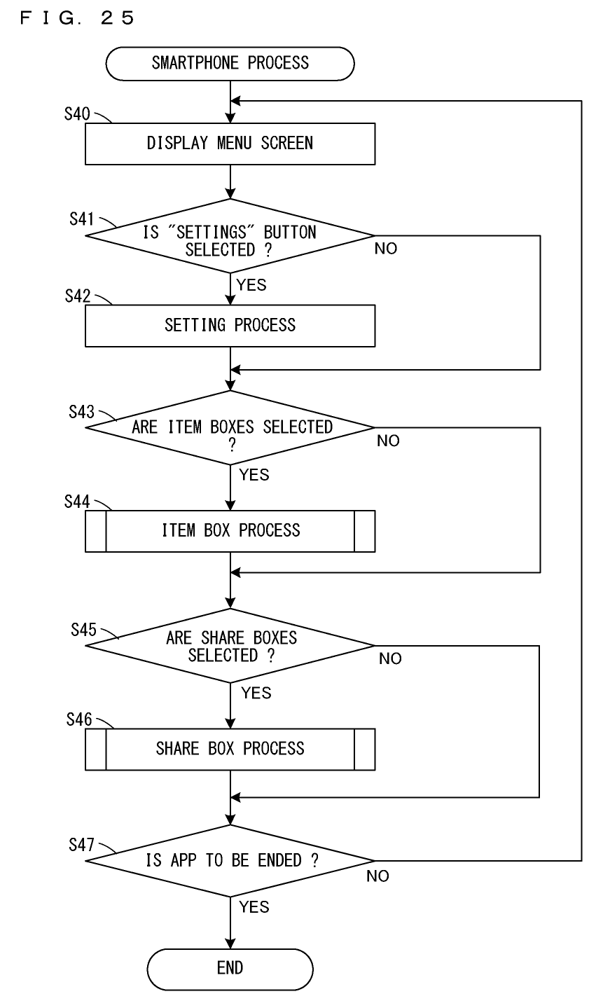

Next, a smartphone process performed by each smartphone 30X is described. FIG. 25 is a flow chart showing an example of the smartphone process performed by the smartphone 30X. The process shown in FIG. 25 is started in accordance with the fact that the user X starts the smartphone app.

As shown in FIG. 25, the smartphone 30X displays a menu screen (step S40). The menu screen displays the icon 401 indicating the item boxes Ix corresponding to the user X, the icon 402 indicating the share boxes Sy of the user Y, and the "settings" button and receives selection operations on these items (see FIG. 9).

Next, the smartphone 30X determines whether or not the "settings" button is selected on the menu screen (step S41).

If the "settings" button is selected (step S41: YES), the smartphone 30X performs a setting process (step S42). Specifically, the smartphone 30X displays a settings screen and receives an operation of the user X on the settings screen. In the setting process, in accordance with an operation of the user X, the setting of the sharing of the item boxes Ix to ON or OFF, the setting of a password for the item boxes Ix, and the like are made. If the sharing of the item boxes Ix is set to ON, the smartphone 30X transmits an instruction to share the item boxes Ix to the server 10 and acquires from the server 10 a URL for another user to access the item boxes Ix. Then, the smartphone 30 generates a two-dimensional code according to the URL and displays the two-dimensional code. The smartphone 30 may acquire a two-dimensional code generated by the server 10. In the setting process, the share boxes of another user are registered. For example, the smartphone 30 displays a screen for reading a two-dimensional code of another user and reads the two-dimensional code. If the smartphone 30 reads the two-dimensional code of the other user, the smartphone 30 registers the share boxes of the other user.

If the determination is NO in step S41, or if the process of step S42 is executed, the smartphone 30X determines whether or not the item boxes Ix are selected (step S43).

If the item boxes Ix is selected(step S43: YES), the smartphone 30X performs an item box process (step S44). The item box process is a process for performing an operation on an item saved in the item boxes Ix of the user X. The details of the item box process will be described below.

If the determination is NO in step S43, or if the process of step S44 is executed, the smartphone 30X determines whether or not any of the one or more share boxes registered by the user X is selected (step S45).

If any of the share boxes is selected (step S45: YES), the smartphone 30X performs a share box process (step S46). The share box process is a process for performing an operation on an item saved in the selected share box. The details of the share box process will be described below.

If the determination is NO in step S45, or if the process of step S46 is executed, the smartphone 30X determines whether or not to end the application (step S47). If it is determined that the application is not to be ended, the processing returns to step S40. If the user gives an end instruction, the smartphone 30X determines that the application is to be ended. Then, the process shown in FIG. 25 ends. This is the description of the process shown in FIG. 25.

### Item Box Process

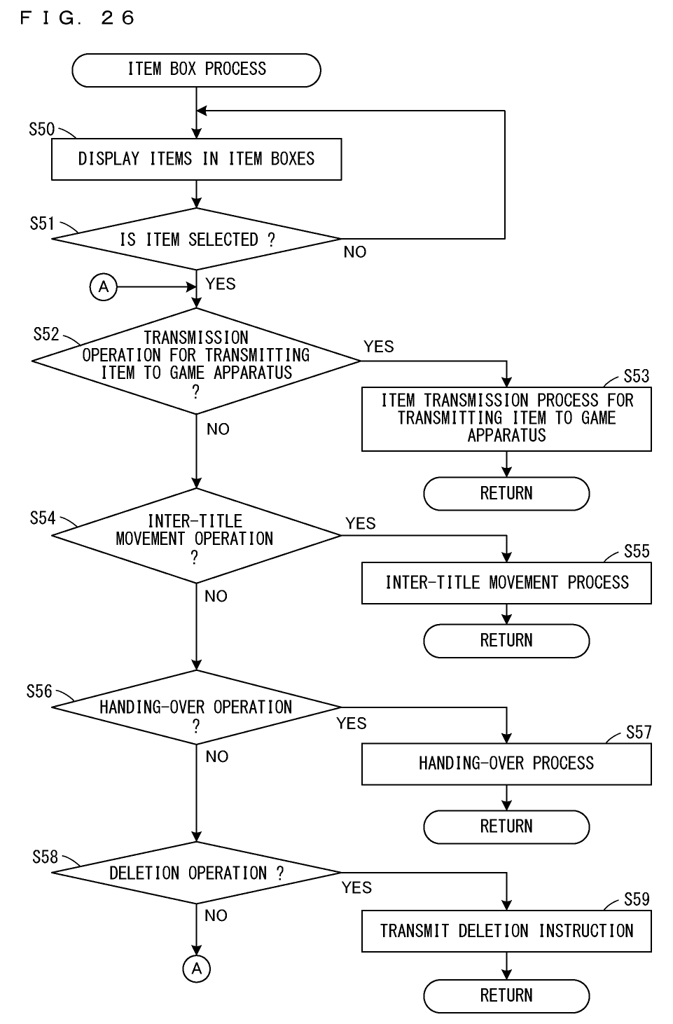

Next, the details of the item box process in step S44 are described. FIG. 26 is a flow chart showing an example of the item box process in step S44.

As shown in FIG. 26, the smartphone 30X displays items in the item boxes Ix (step S50). Specifically, the smartphone 30X accesses the server 10 using the account of the user X and acquires the item IDs and the thumbnail images of items A in the item boxes Ix. Consequently, the item list display area 41 displays a list of items A saved in the item box IAx, and the item list display area 42 displays a list of items B saved in the item box IBx (see FIG. 9).

Next, the smartphone 30X determines whether or not any item is selected from the displayed lists of items (step S51).

If any item is selected (step S51: YES), the smartphone 30X displays the item UI 45 for receiving an operation on the item (see FIG. 10). The smartphone 30X determines whether or not a transmission operation for transmitting the item to the game apparatus 20X (an operation on the "send to game" button) is performed on the item UI 45 (step S52).

If a transmission operation for transmitting the item to the game apparatus 20X is performed (step S52: YES), the smartphone 30X performs an item transmission process for transmitting the item to the game apparatus (step S53). Specifically, the smartphone 30X sends to the server 10 a transmission instruction to transmit the selected item to the game apparatus 20X. Consequently, the server 10 reserves the transmission instruction to transmit the selected item.

If a transmission operation for transmitting the item to the game apparatus 20X is not performed (step S52: NO), the smartphone 30X determines whether or not an inter-title movement operation (an operation on the "inter-title movement" button) is performed (step S54).

If an inter-title movement operation is performed (step S54: YES), the smartphone 30X performs an inter-title movement process for moving the selected item to another game title (step S55). Specifically, the smartphone 30X displays the inter-title movement screen (see FIG. 11) and receives an input of the user. If the "move" button is operated on the inter-title movement screen, the smartphone 30X transmits to the server 10 an inter-title movement instruction to move the selected item to another game title.

If an inter-title movement operation is not performed (step S54: NO), the smartphone 30X determines whether or not an item handing-over operation (an operation on the "give to someone" button) is performed (step S56).

If a handing-over operation is performed (step S56: YES), the smartphone 30X performs a handing-over process for handing over the selected item to another user (step S57). Specifically, the smartphone 30X displays the handing-over screen (see FIG. 12) and receives an input of the user. On the handing-over screen, for example, the user X selects the user Y and operates the "give item" button. In accordance with the operation, the smartphone 30X transmits a handing-over instruction to the server 10. The handing-over instruction includes user information regarding the user of the smartphone 30X having transmitted the instruction, the selected item, and the URL of the share boxes of the selected user. If the share boxes of the selected user do not have a vacancy, the smartphone 30X receives information indicating that the share boxes do not have a vacancy from the server 10, and displays the information.

If a handing-over operation is not performed (step S56: NO), the smartphone 30X determines whether or not a deletion operation is performed (step S58).

If a deletion operation is performed (step S58: YES), the smartphone 30X transmits to the server 10 a deletion instruction to delete the selected item from the item boxes Ix (step S59). Consequently, the selected item is deleted from the item boxes Ix.

If a deletion operation is not performed (step S58: NO), the smartphone 30X executes the process of step S52 again.

If the process of step S53, S55, S57, or S59 is performed, the smartphone 30X ends the process shown in FIG. 26.

### Share Box Process

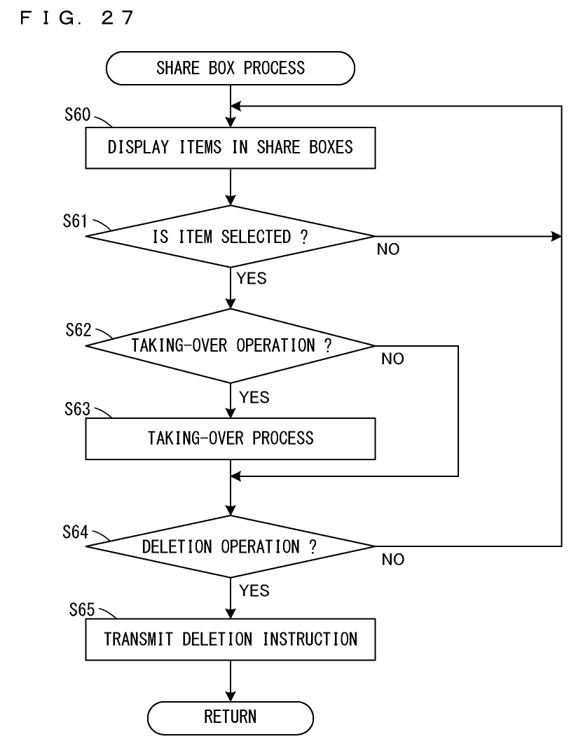

Next, the details of the share box process in step S46 are described. FIG. 27 is a flow chart showing an example of the share box process in step S46. Here, the description is given on the assumption that the share boxes Sy of the user Y are selected.

As shown in FIG. 27, the smartphone 30X displays items in the share boxes Sy (step S60). Specifically, the smartphone 30X accesses the server 10 based on the URL corresponding to the share boxes Sy and acquires information regarding items saved in the item boxes Iy of the user Y. More specifically, the smartphone 30X acquires the item IDs and the thumbnail images of the items in the item boxes Iy. Consequently, the item list display area 43 displays a list of items A saved in the item box IAy, and the item list display area 44 displays a list of items B saved in the item box IBy (see FIG. 13).

Next, the smartphone 30X determines whether or not any item is selected from the displayed lists of items (step S61).

If any item is selected (step S61: YES), the smartphone 30X displays the item UI 45 for performing an operation on the item (see FIG. 14). The smartphone 30X determines whether or not a taking-over operation (an operation on the "take item" button) is performed on the item UI 45 (step S62).

If a taking-over operation is performed (step S62: YES), the smartphone 30X performs a taking-over process for taking over the selected item from the user Y (step S63). Specifically, the smartphone 30X transmits to the server 10 a taking-over instruction to take over the selected item from the user Y. The taking-over instruction includes user information regarding the user of the smartphone 30X having transmitted the instruction, the selected item, and the URL of the share boxes Sy of the user Y. If the item boxes Ix of the user X do not have a vacancy, the smartphone 30X receives information indicating that the item boxes Ix do not have a vacancy from the server 10, and displays the information.

If the determination is NO in step S62, or if the process of step S63 is executed, the smartphone 30X determines whether or not a deletion operation is performed (step S64).

If a deletion operation is performed (step S64: YES), the smartphone 30X transmits to the server 10 a deletion instruction to delete the selected item from the share boxes Sy (the item boxes Iy) (step S65). Consequently, the selected item is deleted from the item boxes Iy.

If a deletion operation is not performed (step S64: NO), the smartphone 30X executes the process of step S60 again. This is the description of the process shown in FIG. 27.

### Server Process

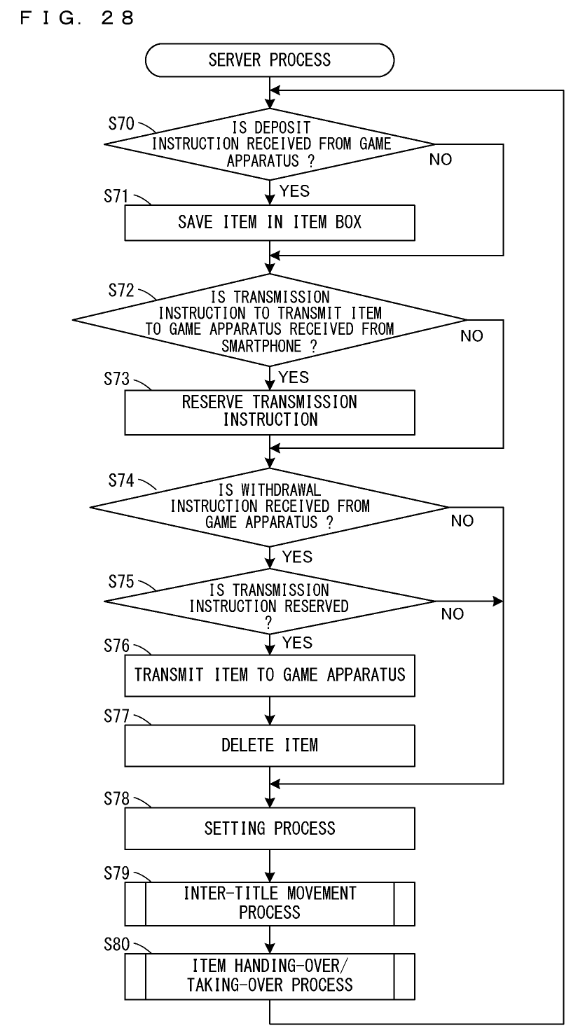

Next, a server process performed by the server 10 is described. FIG. 28 is a flow chart showing an example of the server process performed by the server 10.

As shown in FIG. 28, the server 10 determines whether or not a deposit instruction is received from each game apparatus 20 (step S70). If a deposit instruction is received (step S70: YES), the server 10 saves an item in an item box (step S71). Specifically, the server 10 saves the item ID, the endurance value, and the thumbnail image of the item in an item box corresponding to a user ID included in the deposit instruction. If the item box does not have a vacancy, the server 10 does not save the item in the item box, and transmits information indicating that the item box does not have a vacancy to the game apparatus 20. If the item box does not have a vacancy, the server 10 may delete the oldest item (the earliest saved item) among a plurality of items saved in the item box and save the item included in the deposit instruction.

If the determination is NO in step S70, or if the process of step S71 is executed, the server 10 determines whether or not a transmission instruction to transmit an item to any game apparatus 20 is received from each smartphone 30 (step S72). If a transmission instruction to transmit an item is received (step S72: YES), the server 10 reserves the transmission instruction (step S73). The server 10 reserves transmission instructions from a single user up to a predetermined number. If the number of reserved transmission instructions reaches the predetermined number, the server 10 transmits information indicating that an item cannot be transmitted to the game apparatus 20 to the smartphone 30.

If the determination is NO in step S72, or if the process of step S73 is executed, the server 10 determines whether or not a withdrawal instruction to withdraw an item is received from each game apparatus 20 (step S74). If a withdrawal instruction to withdraw an item is received (step S74: YES), the server 10 determines whether or not a transmission instruction to the game apparatus 20 (the user) having transmitted the withdrawal instruction is reserved (step S75).

If a transmission instruction is reserved (step S75: YES), the server 10 transmits the item ID of an item included in the reserved transmission instruction to the game apparatus 20 (step S76).

Next, the server 10 deletes the item ID of the transmitted item from an item box (step S77).

If the determination is NO in step S74, or if the determination is NO in step S75, or if the process of step S77 is executed, the server 10 performs a setting process (step S78). The setting process in step S78 is a process according to various settings made in a case where the "settings" button is selected in the smartphone app. For example, if the server 10 receives the setting of the sharing of item boxes to ON from each smartphone 30, the server 10 sets the item boxes so that another user can access the item boxes, generates the URL of the item boxes, and transmits the URL to the smartphone 30. The server 10 may generate a two-dimensional code according to the URL and transmit the two-dimensional code to the smartphone 30. If a password for the item boxes is set in the smartphone 30, the server 10 sets the password for the item boxes.

Next, the server 10 executes an inter-title movement process (step S79). After step S79, the server 10 executes an item handing-over/taking-over process (step S80). The details of the inter-title movement process and the item handing-over/taking-over process will be described below.

If the process of step S80 is performed, the server 10 executes the process of step S70 again. This is the description of FIG. 28.

### Inter-Title Movement Process

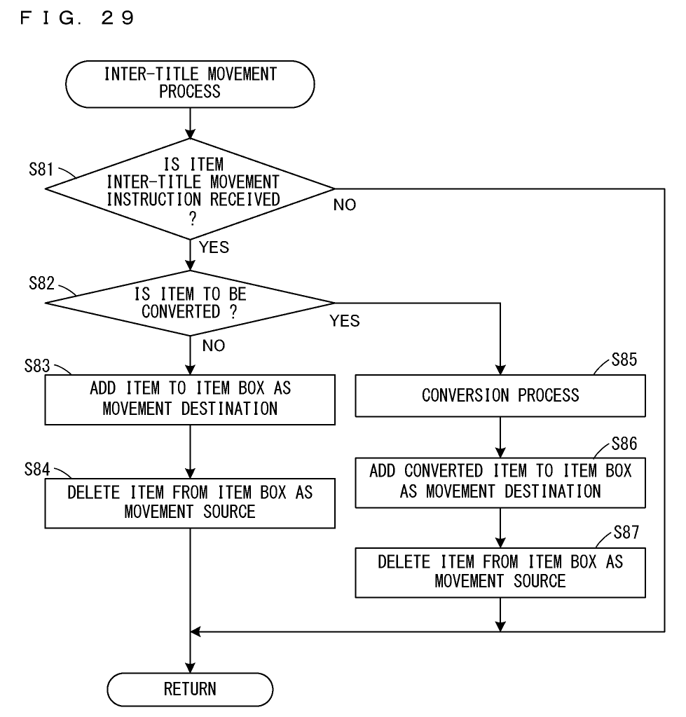

Next, the details of the inter-title movement process in step S79 in FIG. 28 are described. FIG. 29 is a flow chart showing an example of the inter-title movement process in step S79.

As shown in FIG. 29, the server 10 determines whether or not an item inter-title movement instruction is received from each smartphone 30 (step S81).

If an inter-title movement instruction is not received (step S81: NO), the server 10 ends the process shown in FIG. 29.

If an inter-title movement instruction is received (step S81: YES), the server 10 determines whether or not to convert an item (step S82). Based on a conversion rule set in advance, the server 10 determines whether or not to convert the item. For example, if the item to be moved is an item not present in the game title as the movement destination, the server 10 determines that the item is to be converted. If the item to be moved is an item present in the game title as the movement destination, the server 10 determines that the item is not to be converted. If the item to be moved is an item obtained by combining a plurality of types of items, the server 10 determines that the item is to be converted.

If it is determined that the item is not to be converted (step S82: NO), the server 10 adds the item to the item box as the movement destination (step S83). Here, the server 10 adds an item of the same type as the item to be moved to the item box as the movement destination. For example, if an inter-title movement instruction to move the item A1 to the game title TB is received from the smartphone 30X, the server 10 adds the item B1 of the same type as the item A1 to the item box IBx. Even in the case of an item of the same type, the item ID identifying the item changes in association with the inter-title movement. Specifically, the server 10 changes the item ID of the item A1 to the item ID of the item B1 and adds the changed item ID to the item box IBx. If the item box to which to add the item does not have a vacancy, the server 10 transmits information indicating that the item box does not have a vacancy to the smartphone 30. If the item box to which to add the item does not have a vacancy, the server 10 may delete the oldest item (the earliest saved item) among a plurality of items saved in the item box and add the item.

Next, the server 10 deletes the item from the item box as the movement source (step S84). For example, if an inter-title movement instruction to move the item A1 to the game title TB is received from the smartphone 30X, the server 10 deletes the item ID of the item A1 from the item box IAx.

If, on the other hand, it is determined that the item is to be converted (step S82: YES), the server 10 performs a conversion process (step S85). Here, the server 10 converts the item to be moved into another item associated in advance with the item. For example, if an inter-title movement instruction to move the item B2 to the game title TA is received, the server 10 converts the item B2 into the item A2 of a different type set based on a conversion rule. If the item to be moved is an item obtained by combining a plurality of types of items, the server 10 converts the item into the plurality of types of items. For example, if an inter-title movement instruction to move the item B12 to the game title TA is received, the server 10 breaks down the item B12 into the two items B1 and B2 and converts the broken-down items B1 and B2 into the items A1 and A2, respectively.

Next, the server 10 adds the converted item to the item box as the movement destination (step S86). For example, if an inter-title movement instruction to move the item B2 to the game title TA is received from the smartphone 30X, the server 10 adds the item ID of the converted item A2 to the item box IAx. If an inter-title movement instruction to move the item B12 to the game title TA is received from the smartphone 30X, the server 10 adds the item ID of the converted item A1 and the item ID of the converted item A2 to the item box IAx. If the item box to which to add the item does not have a vacancy, the server 10 transmits information indicating that the item box does not have a vacancy to the smartphone 30. If the item box to which to add the item does not have a vacancy, the server 10 may delete the oldest item (the earliest saved item) among a plurality of items saved in the item box and add the item.

Next, the server 10 deletes the item from the item box as the movement source (step S87). For example, if an inter-title movement instruction to move the item B2 to the game title TA is received from the smartphone 30X, the server 10 deletes the item ID of the item B2 from the item box IBx. If an inter-title movement instruction to move the item B12 to the game title TA is received from the smartphone 30X, the server 10 deletes the item ID of the item B12 from the item box IBx.

If the process of step S84 is executed, or if the process of step S87 is executed, the server 10 ends the process shown in FIG. 29.

### Item Handing-Over/Taking-Over Process

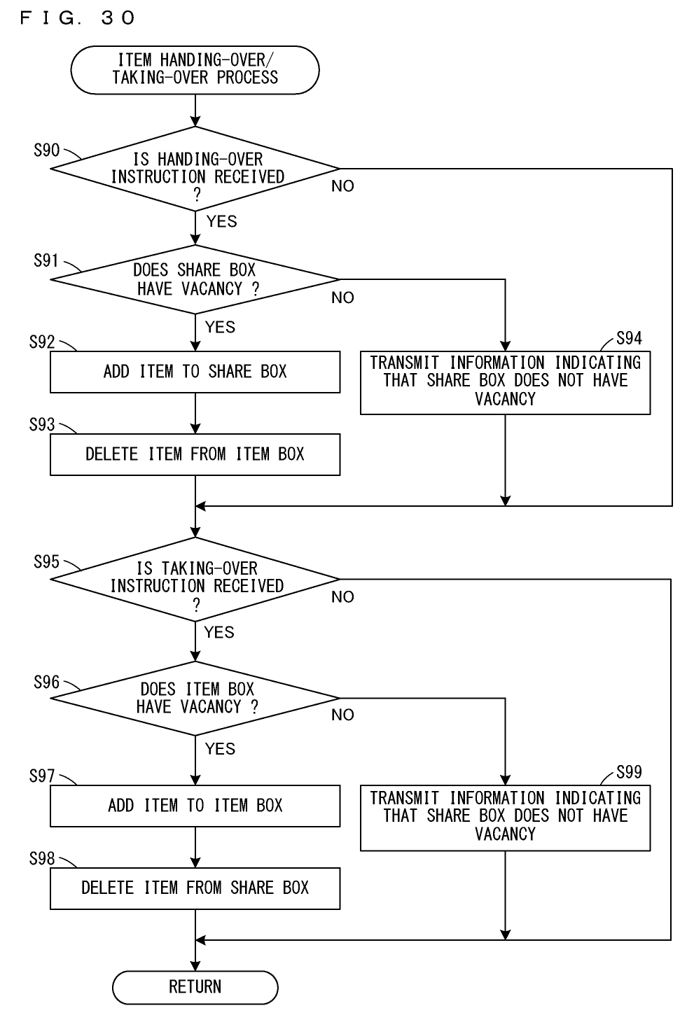

Next, the details of the item handing-over/taking-over process in step S80 in FIG. 28 are described. FIG. 30 is a flow chart showing an example of the item handing-over/taking-over process in step S80.

As shown in FIG. 30, the server 10 determines whether or not an item handing-over instruction is received from each smartphone 30 (step S90).

If a handing-over instruction is received (step S90: YES), the server 10 determines whether or not a share box to which to transmit the item has a vacancy (step 91).

If the share box has a vacancy (step S91: YES), the server 10 adds the item to the share box (step S92) and deletes the item from an item box of the user having transmitted the handing-over instruction (step S93).

If, on the other hand, the share box does not have a vacancy (step S91: NO), the server 10 transmits information indicating that the share box does not have a vacancy to the smartphone 30 (step S94). If the share box does not have a vacancy, the server 10 may delete the oldest item (the earliest saved item) among a plurality of items saved in the share box and save the item included in the handing-over instruction.

If the determination is NO in step S90, or if the process of step S93 is executed, or if the process of step S94 is executed, the server 10 determines whether or not an item taking-over instruction is received from the smartphone 30 (step S95).

If a taking-over instruction is received (step S95: YES), the server 10 determines whether or not an item box to receive the item has a vacancy (step 96).

If the item box has a vacancy (step S96: YES), the server 10 adds the item to the item box of the user having transmitted the taking-over instruction (step S97) and deletes the item from the share box (step S98).

If, on the other hand, the item box does not have a vacancy (step S96: NO), the server 10 transmits information indicating that the item box does not have a vacancy to the smartphone 30 (step S99). If the item box does not have a vacancy, the server 10 may delete the oldest item (the earliest saved item) among a plurality of items saved in the item box and save the item included in the taking-over instruction.

If the determination is NO in step S95, or if the process of step S98 is executed, or if the process of step S99 is executed, the server 10 ends the process shown in FIG. 30.

The processes shown in the above flow charts are merely illustrative, and the order and the contents of the processes, and the like may be appropriately changed.

As described above, the game system according to an exemplary embodiment includes a game apparatus capable of communicating with a server and a communication terminal (e.g., each smartphone 30). The game apparatus can execute each of a first game application (e.g., the game title TA) and a second game application (e.g., the game title TB). During the execution of the first game application, the game apparatus transmits first information (e.g., the item ID of the item A1) corresponding to at least one or more selected first contents to the server 10 based on an operation input, and during the execution of the second game application, the game apparatus transmits second information (e.g., the item ID of the item B2) corresponding to at least one or more selected second contents to the server 10 based on an operation input. The communication terminal acquires the first information and the second information from the server, and based on an operation input, transmits a first instruction to convert the first information into third information (e.g., the item ID of the item B1) associated with a third content that can be used during the execution of the second game application or a second instruction to convert the second information into fourth information (e.g., the item ID of the item A2) corresponding to a fourth content that can be used during the execution of the first game application to the server. During the execution of the first game application, the game apparatus further generates the fourth content corresponding to the fourth information acquired from the server, and during the execution of the second game application, the game apparatus further generates the third content corresponding to the third information acquired from the server.

Consequently, a user can exchange a content between different game applications (e.g., between different game titles in the same series).

The third content may be a content of the same type as the first contents, or may be a content of a different type from the first contents. The fourth content may be a content of the same type as the second contents, or may be a content of a different type from the second contents. The third information may be the same information as the first information, or may be different information from the first information. The fourth information may be the same information as the second information, or may be different information from the second information. The fourth information may include information corresponding to each of a plurality of contents.

The above contents may be an equipment item with which a player character is equipped, or may be an additional item that changes a parameter of the player character.

For example, in a case where the first game application is a previous game and the second game application is a new game, the user can use an equipment item and an additional item acquired in the previous game also in the new game.

In an exemplary embodiment, the first content and the fourth content may be a first equipment item object and a fourth equipment item object, respectively, with which a player character in a virtual space is equipped and for which parameters of endurance values are set during the execution of the first game application. The second content and the third content may be a second equipment item object and a third equipment item object, respectively, with which a player character in a virtual space is equipped and for which parameters of endurance values are set during the execution of the second game application. The game apparatus transmits fifth information regarding the endurance value of the first equipment item object to the server during the execution of the first game application, and transmits sixth information regarding the endurance value of the second equipment item object to the server during the execution of the second game application. The game apparatus generates the fourth equipment item object corresponding to the fourth information acquired from the server during the execution of the first game application, and generates the third equipment item object corresponding to the third information acquired from the server during the execution of the second game application. The endurance value of the fourth equipment item object is set based on the fifth information, and the endurance value of the third equipment item object is set based on the sixth information.

Based on the above, even if an equipment item is converted, an endurance value of the equipment item is carried over. Thus, it is possible to maintain the balance of the game.

In an exemplary embodiment, the game apparatus stores content IDs identifying contents that can be used and information regarding the number of the owned contents during the execution of the first game application or the second game application, transmits content IDs to the server, and in accordance with the number of the content IDs transmitted to the server or content IDs received from the server, updates the information regarding the number of the owned contents corresponding to the transmitted or received content IDs.

In an exemplary embodiment, the game apparatus transmits the first information and a first image representing the first content to the server during the execution of the first game application, and transmits the second information and a second image representing the second content to the server during the execution of the second game application. The communication terminal displays the first image or the second image acquired from the server.

The first information and the first image may be transmitted to the server at the same timing, or may be transmitted to the server at different timings. The same applies to the second information and the second image.

In an exemplary embodiment, upper limits are set on the numbers of times a first instruction and a second instruction are given during a predetermined period.

In an exemplary embodiment, based on an operation input, the communication terminal transmits to the server a third instruction to transmit the first information saved in the server to the game apparatus or a fourth instruction to transmit the second information saved in the server to the game apparatus. The game apparatus generates the first content based on the first information acquired from the server during the execution of the first game application, and generates the second content based on the second information acquired from the server during the execution of the second game application.

In an exemplary embodiment, the number of contents that can be managed using the communication terminal (e.g., the number of items that can be saved in an item box) is greater than the number of contents that can be saved in the game apparatus.

The game system according to an exemplary embodiment also includes a first game apparatus (e.g., 20X), a second game apparatus (e.g., 20Y), and a first communication terminal (e.g., 30X) that are capable of communicating with a server. The first game apparatus can execute a first application associated with a first account (e.g., the account of the user X), and transmits first information associated with a specified first content to the server based on an operation input during the execution of the first application. The second game apparatus can execute the first application associated with a second account (e.g., the account of the user Y), and transmits second information associated with a specified second content to the server based on an operation input during the execution of the first application. The first communication terminal can execute a second application associated with the first account. During the execution of the second application, when a predetermined condition is satisfied (e.g., if the user Y shares their box and the user X registers a share box), the first communication terminal acquires from the server a second information list (e.g., a list of items included in the share boxes Sy) associated with the second account and including the second information. The first communication terminal acquires from the server a first information list (e.g., a list of items included in the item boxes Ix) associated with the first account and including the first information. Based on an operation input, the first communication terminal also transmits to the server a first instruction (e.g., a taking-over instruction) to move second information specified from the second information list to the first information list. During the execution of the first application, the first game apparatus acquires from the server the second information moved to the first information list and generates a third content that can be used in the first application based on the second information.

Consequently, for example, a user can acquire a content acquired in an application by another user and use the acquired content in an application of the user.

The third content may be a content of the same type as the first content, or may be a content of a different type from the first content. The third information may be the same information as the first information, or may be different information from the first information. The above contents may be equipment items with which a player character is equipped, or may be additional items that change parameters of the player character.

In an exemplary embodiment, the game system further includes a second communication terminal capable of connecting to the server. The second communication terminal may be able to execute a third application associated with the second account, and acquire the second information list from the server and generate an image associated with the second information list or acquire an image associated with the second information list from the server during the execution of the third application. The first communication terminal may acquire the second information list from the server based on the image.

In an exemplary embodiment, an upper limit may be set on the number of times the above first instruction to move information included in the second information list to the first information list is given during a predetermined period.

In an exemplary embodiment, the first game apparatus may control a player character in a virtual space based on an operation input during the execution of the first application, and set a first area (e.g., a transmission hole) in the virtual space. If the player character is included in the first area, the first game apparatus may transmit the first information to the server.

In an exemplary embodiment, during the execution of the first application, the first game apparatus may set a second area in the virtual space and cause the third content generated based on the second information to appear from the second area (e.g., a reception hole).

### Variations

While an exemplary embodiment has been described above, an exemplary embodiment is merely an example and may be modified as follows, for example.

For example, in an exemplary embodiment, as a content in a game, an item is saved in a server. In another exemplary embodiment, information corresponding to not only an item but also any other content may be saved in the server. For example, as the information corresponding to the content, information corresponding to a character may be saved in the server.

In an exemplary embodiment, the number of contents that can be managed using a communication terminal is greater than the number of contents that can be saved in a game apparatus. In another exemplary embodiment, the number of contents that can be managed using the communication terminal may be smaller than or equal to the number of contents that can be saved in the game apparatus. A substantial limitation may not be placed on the number of contents that can be managed using the communication terminal.

In an exemplary embodiment, contents (e.g., items) that can be used in a game application are saved in a "pouch", and the substance of the "pouch" is a storage medium connected to the game apparatus 20. In another exemplary embodiment, the substance of the "pouch" may be a storage medium on a network (e.g., the server 10 or a server different from the server 10) that can be accessed by the game apparatus 20. That is, if the game apparatus 20 can extract or save a content in accordance with an operation of the user, the substance of the "pouch" may be a storage medium directly connected to the game apparatus 20, or may be a storage medium to which the game apparatus 20 can connect via the network, or may be a combination of these.

In an exemplary embodiment, the user sets the sharing of their item box to ON, directly sends a two-dimensional code to another user or uploads the two-dimensional code to an SNS. Then, the user individually sets a content that can be shared, and reads a two-dimensional code corresponding to an item box of another user, thereby registering a share box. The user and another user each register a share box of the other using a two-dimensional code, and send a content to the share box or receive a content from the share box.

In an exemplary embodiment, an item ID is moved between an item box for a first application of a first user and an item box for the first application of a second user, thereby transmitting and receiving an item related to the same application to and from the users. In another exemplary embodiment, an item related to not only the same application but also, for example, applications in different versions may be able to be transmitted and received to and from users. For example, an item in a first application owned by a first user may be transmitted to a second user, and the second user may use the received item in a second application. For example, an item ID stored in an item box for the first application of the first user may be moved to an item box for the second application of the second user, whereby the second user may be able to use the item related to the first application owned by the first user in the second application.

In another exemplary embodiment, when the user receives a content from another user, the user may directly send a two-dimensional code corresponding to their item box to the other user or upload the two-dimensional code to an SNS or the like. Then, contents uploaded by the other user may be accumulated in a server, and the user may automatically receive contents corresponding to vacancies from the server when an app is started. A configuration may be employed in which when the user sends a content to another user, the user reads a two-dimensional code of the other user, and selects a content to be sent to the other user from a menu of individual contents. Then, if the user gives a sending instruction, a selected content is sent to the server and accumulated in the server.

In another exemplary embodiment, when the user receives a content from another user, the user may directly send a two-dimensional code corresponding to their item box to the other user or upload the two-dimensional code to an SNS, and automatically receive a content from a server when an app is started. A configuration may be employed in which when the user sends a content to another user, the user reads a two-dimensional code of the other user, and selects a content to be sent to the other user from a menu of individual contents. Then, if the user gives a sending instruction, and only if a share box as the destination has a vacancy, the transmission of the content becomes successful.

In another exemplary embodiment, the user may select "upload to SNS" from a menu of individual contents, thereby uploading a two-dimensional code associated with a single selected content. A configuration may be employed in which another user reads the two-dimensional code on an SNS, and if the two-dimensional code is in a valid state and an item box of the other user has a vacancy, the other user can receive the content. If the other user receives the content, a server sets this URL to an invalid state.

In another exemplary embodiment, the user may select a plurality of contents from a menu of individual contents and select "upload to SNS", thereby uploading a two-dimensional code associated with the plurality of contents. A configuration may be employed in which another user reads the two-dimensional code on an SNS, and if the two-dimensional code is in a valid state and an item box of the other user has a vacancy, the other user can receive the contents. The number of times the two-dimensional code can be read by a single user during a predetermined period may be limited. For example, a limitation of a single person once a day is placed.

In another exemplary embodiment, the user may select a plurality of contents from a menu of individual contents, select whether or not to place a limitation of a single content for a single person, and select "upload to SNS", thereby uploading a two-dimensional code associated with a plurality of contents. By default, the limitation of a single content for a single person may be placed, or the limitation may not be placed. A configuration may be employed in which another user reads the two-dimensional code on an SNS, and if the two-dimensional code is in a valid state and an item box of the other user has a vacancy, the other user can receive a content. If the limitation of a single content for a single person is placed, the other user can receive only a single content. If such a limitation is not placed, the other user may be able to receive as many contents as vacancies of the item box. The number of times the two-dimensional code can be read by a single user during a predetermined period may be limited. For example, a limitation of a single person three times a day may be placed.

In an exemplary embodiment, a configuration is employed in which a communication terminal (e.g., a smartphone) or a server generates a two-dimensional code, and another user acquires the two-dimensional code, thereby accessing a share box or an uploaded content. In another exemplary embodiment, the other user may acquire not only the two-dimensional code but also a one-dimensional code (a barcode) or a URL and access the share box or the uploaded content.

In an exemplary embodiment, in a case where an inter-title movement is made, a server converts the type of an item and converts the item ID. In another exemplary embodiment, a communication terminal may convert the type of the item and convert the item ID.

A part of the processing performed by each apparatus (a game apparatus, a server, or a smartphone) included in the above game system may be performed by another apparatus.

The configurations of an exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A game system including a first game apparatus, a second game apparatus, and a first communication terminal,
the first game apparatus configured to perform operations comprising:
executing a first application associated with a first account; and
during the execution of the first application, based on an operation input, transmitting first information associated with a specified first content to a server,
the second game apparatus configured to perform operations comprising:
executing the first application associated with a second account; and
during the execution of the first application, based on an operation input, transmitting second information associated with a specified second content to the server,
the first communication terminal configured to perform operations comprising:
executing a second application associated with the first account; and
during the execution of the second application,
when a predetermined condition is satisfied, acquiring a second information list associated with the second account and including the second information from the server,
acquiring a first information list associated with the first account and including the first information from the server, and
based on an operation input, transmitting to the server a first instruction to move the second information specified from the second information list to the first information list, and
the first game apparatus further configured to perform operations comprising:
during the execution of the first application,
acquiring from the server the second information moved to the first information list, and
based on the second information, generating a third content that can be used in the first application.

2. The game system according to claim 1, further including a second communication terminal capable of connecting to the server, wherein
the second communication terminal is configured to perform operations comprising:
executing a third application associated with the second account; and
during the execution of the third application,
acquiring the second information list from the server, and
generating an image associated with the second information list or acquiring the image from the server, and
the first communication terminal is further configured to perform operations comprising:
acquiring the second information list from the server based on the image.

3. The game system according to claim 1, wherein
the first content is a first equipment item object with which a player character in a virtual space is equipped during the execution of the first application, or is a first additional item object that changes a parameter regarding an ability of the player character during the execution of the first application, and
the second content is a second equipment item object with which a player character in a virtual space is equipped during the execution of the first application, or is a second additional item object that changes a parameter regarding an ability of the player character during the execution of the first application.

4. The game system according to claim 1, wherein an upper limit is set on the number of times the first instruction is given during a predetermined period.

5. The game system according to claim 1, wherein the number of contents that can be managed using the first communication terminal is greater than the number of contents that can be saved in the first game apparatus.

6. The game system according to claim 1, wherein
the first game apparatus is further configured to perform operations comprising:
during the execution of the first application,
based on an operation input, acquiring the second information included in the first information list from the server.

7. The game system according to claim 1, wherein
the first game apparatus is further configured to perform operations comprising:
during the execution of the first application,
based on an operation input, controlling a player character in a virtual space,
setting a first area in the virtual space, and
when the first content is included in the first area, transmitting the first information to the server.

8. The game system according to claim 7, wherein
the third content is an object that can be used by the player character, and
the first game apparatus is further configured to perform operations comprising:
during the execution of the first application,
setting a second area in the virtual space, and
causing the third content generated based on the second information to appear from the second area.

9. A computer-implemented method performed by a game system including a first game apparatus, a second game apparatus, and a first communication terminal,
the first game apparatus configured to perform operations comprising:
executing a first application associated with a first account; and
during the execution of the first application, based on an operation input, transmitting first information associated with a specified first content to a server,
the second game apparatus configured to perform operations comprising:
executing the first application associated with a second account; and
during the execution of the first application, based on an operation input, transmitting second information associated with a specified second content to the server,
the first communication terminal configured to perform operations comprising:
executing a second application associated with the first account; and
during the execution of the second application,
when a predetermined condition is satisfied, acquiring a second information list associated with the second account and including the second information from the server,
acquiring a first information list associated with the first account and including the first information from the server, and
based on an operation input, transmitting to the server a first instruction to move the second information specified from the second information list to the first information list, and
the first game apparatus further configured to perform operations comprising:
during the execution of the first application,
acquiring from the server the second information moved to the first information list, and
based on the second information, generating a third content that can be used in the first application.

10. The computer-implemented method according to claim 9, wherein
the game system further includes a second communication terminal capable of connecting to the server,
the second communication terminal is configured to perform operations comprising:
executing a third application associated with the second account; and
during the execution of the third application,
acquiring the second information list from the server, and
generating an image associated with the second information list or acquiring the image from the server, and
the first communication terminal is further configured to perform operations comprising:
acquiring the second information list from the server based on the image.

11. The computer-implemented method according to claim 9, wherein
the first content is a first equipment item object with which a player character in a virtual space is equipped during the execution of the first application, or is a first additional item object that changes a parameter regarding an ability of the player character during the execution of the first application, and
the second content is a second equipment item object with which a player character in a virtual space is equipped during the execution of the first application, or is a second additional item object that changes a parameter regarding an ability of the player character during the execution of the first application.

12. The computer-implemented method according to claim 9, wherein an upper limit is set on the number of times the first instruction is given during a predetermined period.

13. The computer-implemented method according to claim 9, wherein the number of contents that can be managed using the first communication terminal is greater than the number of contents that can be saved in the first game apparatus.

14. The computer-implemented method according to claim 9, wherein
the first game apparatus is further configured to perform operations comprising:
during the execution of the first application,
based on an operation input, acquiring the second information included in the first information list from the server.

15. The computer-implemented method according to claim 9, wherein
the first game apparatus is further configured to perform operations comprising:
during the execution of the first application,
based on an operation input, controlling a player character in a virtual space,
setting a first area in the virtual space, and
when the first content is included in the first area, transmitting the first information to the server.

16. The computer-implemented method according to claim 15, wherein
the third content is an object that can be used by the player character, and
the first game apparatus is further configured to perform operations comprising:
during the execution of the first application,
setting a second area in the virtual space, and
causing the third content generated based on the second information to appear from the second area.

17. One or more non-transitory computer-readable media having stored therein instructions that, when executed, cause processing circuits to execute operations comprising:
executing a first application associated with a first account in a first game apparatus;
during the execution of the first application in the first game apparatus, based on an operation input, transmitting first information associated with a specified first content to a server;
executing the first application associated with a second account in a second game apparatus; and
during the execution of the first application in the second game apparatus, based on an operation input, transmitting second information associated with a specified second content to the server, wherein
a first communication terminal capable of communicating with the server is configured to perform operations comprising:
executing a second application associated with the first account;
during the execution of the second application,
when a predetermined condition is satisfied, acquiring a second information list associated with the second account and including the second information from the server,
acquiring a first information list associated with the first account and including the first information from the server, and
based on an operation input, transmitting to the server a first instruction to move the second information specified from the second information list to the first information list,
the operations further comprising:
during the execution of the first application in the first game apparatus,
acquiring from the server the second information moved to the first information list, and
based on the second information, generating a third content that can be used in the first application.
